(19) United States
(12) Patent Application Publication
(10) Pub. No.: US 2021/0201910 A1
(43) Pub. Date: Jul. 1, 2021

(54) VOICE OPERATION ASSISTANCE SYSTEM, VOICE PROCESSING DEVICE, AND VOICE OPERATION ASSISTANCE DEVICE (as amended)

(71) Applicant: Mitsubishi Electric Corporation, Tokyo (JP)

(72) Inventor: Nobuo ASAHI, Tokyo (JP)

(21) Appl. No.: 17/270,988

(22) PCT Filed: Oct. 5, 2018
(86) PCT No.: PCT/JP2018/037424

§ 371 Date: Feb. 24, 2021

(51) Int. Cl. G10L 15/22; G10L 15/30

(52) U.S. Cl. CPC G10L 15/22; G10L 15/30; G06F 16/245; G10L 2015/223; G10L 2015/228

(57) ABSTRACT

A voice operation assistance system includes voice data receiving means, reply information generating means, and voice data sending means. The voice data receiving means receives first voice data based on voice of a user from a voice input/output device (3). When the received first voice data indicates an inquiry about an operation in a home appliance (2) that the user has, the reply information generating means generates reply information in reply to the inquiry with reference to an operation explanation information database in which, for each home appliance type, one or more manufacturer-specific operations of each of a plurality of manufacturers relative to the home appliance type are each associated with information indicating an explanation. The voice data sending means sends, to the voice input/output device (3), second voice data indicating voice based on the generated reply information.

### TECHNICAL FIELD

The present disclosure relates to a voice operation assistance system, a voice operation system, a voice processing device, a voice operation assistance device, a voice operation assistance method, and a program.

### BACKGROUND ART

Various proposals have been made to a system for controlling indoor home appliances based on a result of recognition, by an outdoor server, of a user's voice that is input via a voice input device installed in an indoor space (for example, Patent Literature 1).

This type of system under recent development has a configuration of providing a voice operation service by cooperation between a server (hereinafter referred to as a first server) that performs voice recognition and is operated by a manufacturer who is a voice input device seller and a server (hereinafter referred to as a second server) that performs control of home appliances and is operated by a manufacturer who is a home appliance seller.

Specifically, the above system, in which the first server and a plurality of such second servers of different manufacturers are connected via the Internet, is designed to perform similar control over the same type of home appliances (e.g., air conditioners) made by different manufacturers, by common voice operation that is manufacturer-independent.

### CITATION LIST

### Patent Literature

Patent Literature 1: International Publication No. WO2014/171144

### SUMMARY OF INVENTION

### Technical Problem

However, the above common voice operation is limited to an operation corresponding to a basic operation, such as on/off operation of a power source, start/end of an operation, or the like. Thus, a user cannot easily use the home appliances to perform an operation that is manufacturer-specific, and in practice the home appliances the user owns are not utilized sufficiently.

In view of the above circumstances, an objection of the present disclosure is to provides a voice operation assistance system and the like that enable a user to sufficiently utilize home appliances that the user has.

### Solution to Problem

To achieve the above objective, a voice operation assistance system according to the present disclosure includes

voice data receiving means for receiving, from a voice input/output device, first voice data based on voice of a user,

reply information generating means for, when the received first voice data indicates an inquiry about an operation for a home appliance that the user has, generating reply information in reply to the inquiry with reference to an operation explanation information database in which, for each home appliance type, one or more manufacturer-specific operations of each of a plurality of manufacturers relative to the home appliance type are each associated with information indicating an explanation; and

voice data sending means for sending to the voice input/output device second voice data indicating voice based on the reply information.

### Advantageous Effects of Invention

The present disclosure enables the user to sufficiently utilize home appliances that the user has.

### BRIEF DESCRIPTION OF DRAWINGS

FIG. 1 is a diagram illustrating an overall configuration of a voice operation system including a voice operation assistance system according to Embodiment 1 of the present disclosure;

FIG. 2 is a block diagram illustrating a hardware configuration of a voice input/output device according to Embodiment 1;

FIG. 3 is a block diagram illustrating a functional configuration of the voice input/output device according to Embodiment 1:

FIG. 4 is a block diagram illustrating a hardware configuration of a voice processing device according to Embodiment 1:

FIG. 5 is a diagram for describing a secondary storage included in the voice processing device according to Embodiment 1;

FIG. 6 is a diagram for describing an appliance operation information database (DB) stored in the secondary storage included in the voice processing device according to Embodiment 1;

FIG. 7 is a diagram for describing a customer appliance information DB stored in the secondary storage included in the voice processing device according to Embodiment 1;

FIG. 8 is a block diagram illustrating a hardware configuration of an appliance control device according to Embodiment 1;

FIG. 9 is a diagram for describing a secondary storage included in the appliance control device according to Embodiment 1;

FIG. 10 is a diagram for describing the appliance operation information DB stored in the secondary storage included in the appliance control device according to Embodiment 1;

FIG. 11 is a diagram for describing the customer appliance information DB stored in the secondary storage included in the appliance control device according to Embodiment 1;

FIG. 12 is a block diagram illustrating a hardware configuration of a voice operation assistance device according to Embodiment 1;

FIG. 13 is a diagram for describing a secondary storage included in the voice operation assistance device according to Embodiment 1;

FIG. 14 is a diagram for describing an operation explanation information DB (air conditioner) stored in the secondary storage included in the voice operation assistance device according to Embodiment 1;

FIG. 15 is a diagram for describing the operation explanation information DB (television) stored in the secondary storage included in the voice operation assistance device according to Embodiment 1;

FIG. 16 is a diagram for describing an appliance information DB stored in the secondary storage included in the voice operation assistance device according to Embodiment 1;

FIG. 17 is a block diagram illustrating a functional configuration of the voice processing device according to Embodiment 1;

FIG. 18 is a diagram illustrating a configuration of operation information in Embodiment 1;

FIG. 19 is a diagram illustrating an example of a correspondence relationship between utterance content of a user and operation information to be generated, in Embodiment 1;

FIG. 20 is a diagram illustrating a configuration of request information in Embodiment 1;

FIG. 21 is a diagram for describing a request number in Embodiment 1;

FIG. 22 is a diagram illustrating an example of a correspondence relationship between utterance content of a user and request information to be generated, in Embodiment 1;

FIG. 23 is a flowchart illustrating steps of voice processing in Embodiment 1;

FIG. 24 is a flowchart illustrating steps of an operation information generating process in Embodiment 1:

FIG. 25 is a flowchart illustrating steps of a request information generating process in Embodiment 1;

FIG. 26 is a block diagram illustrating a functional configuration of the appliance control device according to Embodiment 1;

FIG. 27 is a block diagram illustrating a functional configuration of the voice operation assistance device according to Embodiment 1,

FIG. 28 is a diagram illustrating an example of a correspondence relationship between request information and reply information to be generated, in Embodiment 1;

FIG. 29 is a flowchart illustrating steps of the voice operation assistance process in Embodiment 1;

FIG. 30 is a diagram illustrating an overall configuration of a voice operation system including a voice operation assistance system according to Embodiment 2 of the present disclosure:

FIG. 31 is a block diagram illustrating a functional configuration of a voice processing device according to Embodiment 2;

FIG. 32 is a diagram illustrating a configuration of second request information in Embodiment 2;

FIG. 33 is a diagram for describing a request number in Embodiment 2;

FIG. 34 is a diagram illustrating an example of a correspondence relationship between utterance content of a user and second request information to be generated, in Embodiment 2;

FIG. 35 is a diagram for describing a secondary storage included in the voice operation assistance device according to Embodiment 2;

FIG. 36 is a diagram for describing an actual-operation-performance information DB stored in the secondary storage included in the voice operation assistance device according to Embodiment 2;

FIG. 37 is a block diagram illustrating a functional configuration of the voice operation assistance device according to Embodiment 2;

FIG. 38 is a diagram for describing a tendency of use in Embodiment 2;

FIG. 39 is a diagram for describing a tendency of use in Embodiment 2;

FIG. 40 is a diagram illustrating an example of a correspondence relationship between second request information and advice information to be generated, in Embodiment 2;

FIG. 41 is a diagram illustrating an overall configuration of a voice operation system including a voice operation assistance system according to Embodiment 3 of the present disclosure;

FIG. 42 is a diagram for describing a secondary storage included in a voice processing device according to Embodiment 3;

FIG. 43 is a diagram for describing a customer appliance information DB stored in the secondary storage included in the voice processing device according to Embodiment 3;

FIG. 44 is a diagram for describing an operation history DB stored in the secondary storage included in the voice processing device according to Embodiment 3;

FIG. 45 is a diagram for describing the operation history DB stored in the secondary storage included in the voice processing device according to Embodiment 3;

FIG. 46 is a diagram for describing an operation sequence DB stored in the secondary storage included in the voice processing device according to Embodiment 3;

FIG. 47 is a block diagram illustrating a functional configuration of the voice processing device according to Embodiment 3;

FIG. 48 is a diagram for describing parameters for calculating a continuation index in Embodiment 3; and

FIG. 49 is a diagram illustrating an example of a consecutive operations table in Embodiment 3.

### DESCRIPTION OF EMBODIMENTS

Embodiments of the present disclosure are hereinafter described in detail with reference to the drawings.

### Embodiment 1

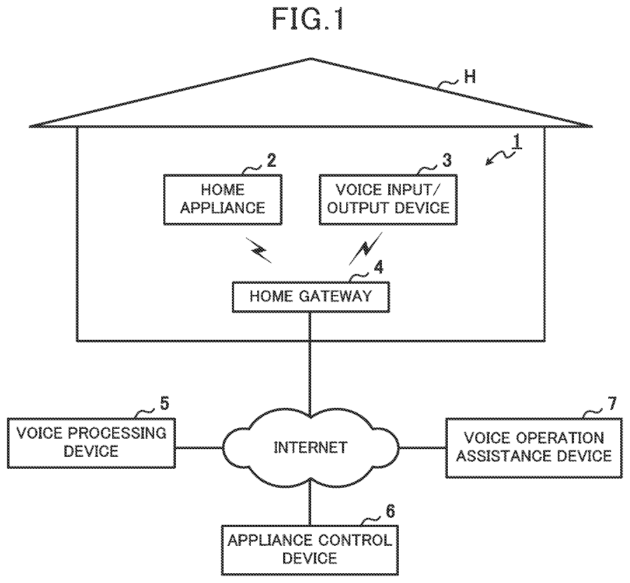

FIG. 1 is a diagram illustrating an overall configuration of a voice operation system 1 including a voice operation assistance system according to Embodiment 1 of the present disclosure. The voice operation system 1 is a system that enables voice operation control of one or more home appliances 2 installed at house H. The voice operation system 1 includes the one or more home appliances 2, a voice input/output device 3, a home gateway 4, a voice processing device 5, an appliance control device 6, and a voice operation assistance device 7. A voice operation assistance system according to Embodiment 1 is a system for assisting in voice operation by a user, and includes the voice input/output device 3, the home gateway 4, the voice processing device 5, and the voice operation assistance device 7.

Examples of the home appliances 2 include an air conditioner (AC), a television (IN) and an induction heating (IH) cooker that are installed in a house H, including premises thereof. The home appliances 2 are also known as so-called Internet of Things (IoT) appliances, information home appliances, networked home appliances, smart home appliances, or the like. The home appliances 2 are connected to the Internet through the home gateway 4 having capabilities of a broadband router.

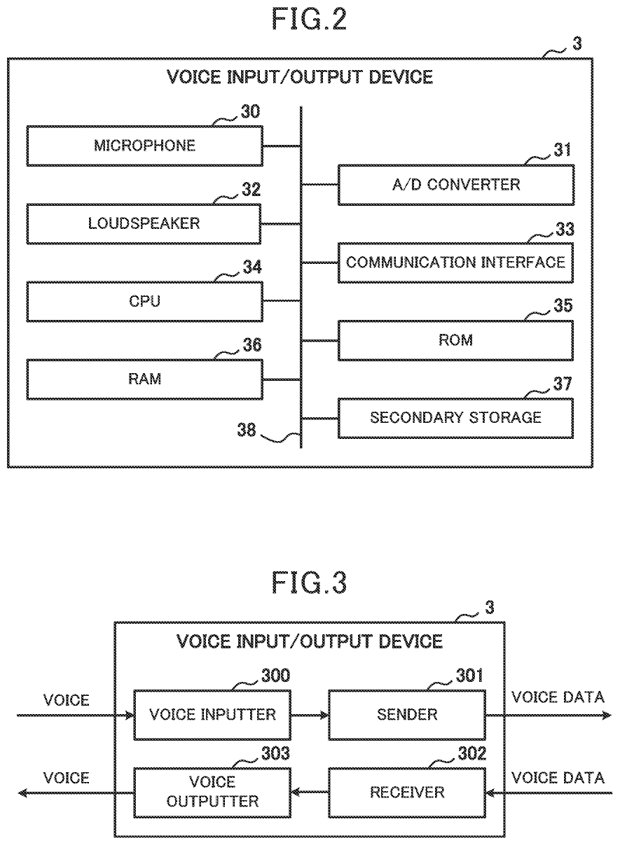

The voice input/output device 3 is an example of the voice input/output device according to the present disclosure. The voice input/output device 3 is a device that provides various services based on voice input by use's utterance, and is a so-called artificial intelligence (AI) speaker, also known as a smart speaker. As illustrated in FIG. 2, the voice input/output device 3 includes a microphone 30, an analog/digital (A/D) converter 31, a loudspeaker 32, a communication interface 33, a central processing unit (CPU) 34, a read only memory (ROM) 35, a random access memory (RAM) 36, and a secondary storage 37. These components are connected to one another via a bus 38.

The microphone 30 receives a voice originated from a user, generates an analog voice signal from the received voice, and outputs the signal to the A/D converter 31. The A/D converter 31 eliminates noise from the analog voice signal output by the microphone 30, generates a digital voice signal, and supplies the signal to the CPU 34. The loudspeaker 32 outputs voice corresponding to the digital voice signal supplied from the CPU 34.

The communication interface 33 communicatively connects to the home gateway 4 in a wired or wireless way, and includes a network card for communication through the home gateway 4 with the voice processing device 5 connected to the Internet.

The CPU 34 comprehensively controls the voice input/output device 3. Functions of the voice input/output device 3 achieved by the CPU 34 are described in detail later. The ROM 35 stores firmware and data for use at execution of the firmware. The RAM 36 is used as a working area for the CPU 34.

The secondary storage 37 includes a readable and writable non-volatile semiconductor memory such as an electrically erasable programmable read-only memory (EEPROM), a flash memory, or the like, or includes a hard disk drive (HDD). The secondary storage 37 stores a voice input/output program and data for use in execution of the voice input/output program. The voice input/output program is a program having descriptions of processing of inputting a user's voice and sending to the voice processing device 5 voice data based on the input voice, and processing of receiving the voice data from the voice processing device 5 and outputting voice based on the received voice data.

As illustrated in FIG. 3, the voice input/output device 3 functionally includes a voice inputter 300, a sender 301, a receiver 302, and a voice outputter 303. These functional components are achieved by the CPU 34 executing the aforementioned voice input/output program stored in the secondary storage 37.

The voice inputter 300 inputs a voice originated from a user and generates voice data based on the input voice. Specifically, the voice inputter 300 applies pulse code modulation (PCM) to an analog voice signal indicating the voice of the user to convert the analog voice signal into a digital voice signal, and further applies lossy compression to the digital voice signal to generate voice data.

The sender 301 sends to the voice processing device 5 via the home gateway 4 the voice data generated by the voice inputter 300.

The receiver 302 receives via the home gateway 4 the voice data sent from the voice processing device 5. The voice outputter 303 outputs voice based on the voice data received by the receiver 302.

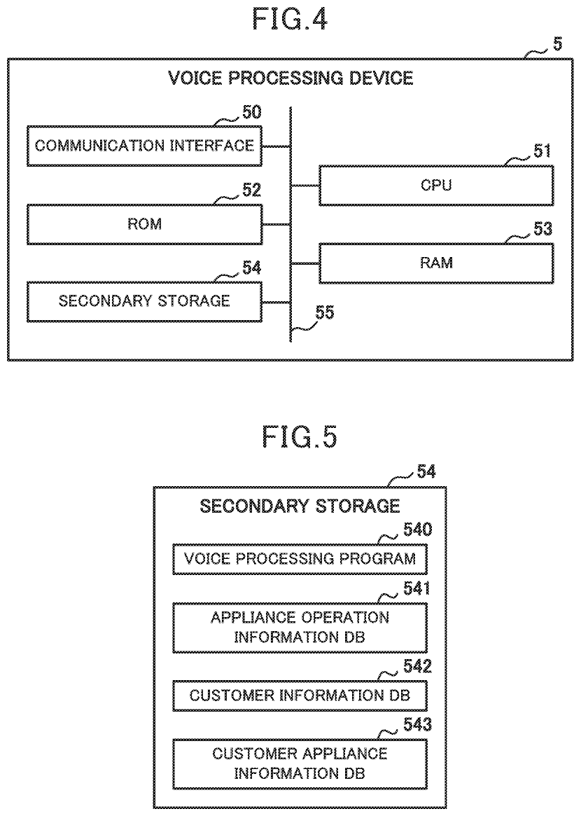

Again with reference to FIG. 1, the voice processing device 5 is an example of a voice processing device according to the present disclosure. The voice processing device 5 is a server computer installed and operated by a manufacturer, a supplier, or the like of the voice input/output device 3, and is connected to the Internet. The voice processing device 5 achieves a voice operation for the home appliances 2 in cooperation with the voice input/output device 3 and the later-described appliance control device 6. Furthermore, the voice processing device 5 provides services for assisting the voice operation to the user in cooperation with the voice input/output device 3 and the later-described voice operation assistance device 7. As illustrated in FIG. 4, the voice processing device 5 includes a communication interface 50, a CPU 51, a ROM 52, a RAM 53, and a secondary storage 54. These components are connected to one another via a bus 55.

The communication interface 50 is a device for communication with another device, such as the home gateway 4, the appliance control device 6, the voice operation assistance device 7, and the like, by connection to the Internet. The CPU 51 comprehensively controls the voice processing device 5. Functions of the voice processing device 5 achieved by the CPU 51 are described in detail later.

The ROM 52 stores firmware and data for use at execution of the firmware. The RAM 53 is used as a working area for the CPU 51.

The secondary storage 54 is a mass storage device including a readable and writable non-volatile semiconductor memory such as EEPROM, flash memory, or the like, or an HDD. As illustrated in FIG. 5, the secondary storage 54 includes a voice processing program 540, an appliance operation information DB 541, a customer information DB 542, and a customer appliance information DB 543. In addition, the secondary storage 54 stores, for example, a voice recognition DB that is a database for voice recognition.

The voice processing program 540 is a program for voice processing for achieving a voice operation service. The voice processing program 540 has descriptions of voice data analysis processing, appliance operation relevant processing, operation assistance relevant processing, and the like.

The voice data analysis processing includes processing of analyzing the voice data sent by the voice input/output device 3 using the aforementioned voice recognition DB, and acquiring content of the voice. The appliance operation relevant processing includes processing of generating operation information for the home appliance 2 based on the content of the acquired voice and sending the operation information to the appliance control device 6, and processing of sending to the voice input/output device 3 the voice data based on result information from the appliance control device 6. The operation assistance relevant processing includes processing of sending to the voice operation assistance device 7 request information for requesting a reply to an inquiry from the user about the operation of the home appliances 2, and processing of sending to the voice input/output device 3 the voice data based on reply information from the voice operation assistance device 7.

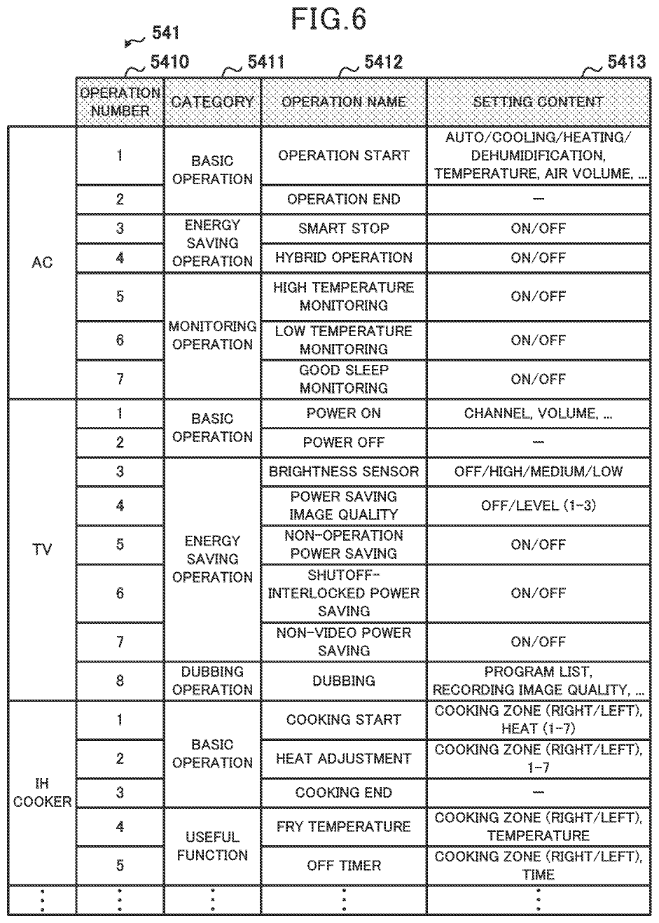

The appliance operation information DB 541 is a database in which information relating to all the operations relevant to types of the home appliances 2 is registered for each of the types. Specifically, as illustrated in FIG. 6, the appliance operation information DB 541 has, for each of the types of the home appliances 2, registered records of items including an operation number 5410, a category 5411, an operation name 5412, setting content 5413, and the like. In the present embodiment, the type means the kind of appliances (e.g., air conditioner, television, IH cooker, and the like) based on a fundamental function provided for the home appliance 2.

The operation number 5410 stores an operation number, and the operation number is a number assigned uniquely to each operation in the type. The category 5411 stores a category name corresponding to the operation number stored in the operation number 5410. The category name is a name indicating classification of a property of the operation in the type. For example, in a case where the type of the home appliance 2 is an air conditioner, the category 5411 stores any one of operations that are “basic operation”, “energy saving operation”, and “monitoring operation”. As another example, in a case where the type of the home appliance 2 is a television, the category 5411 stores any one of operations that are “basic operation”. “energy saving operation”, and “dubbing operation”.

In the present embodiment, the operation with a category name corresponding to “basic operation” (for an AC, for example, operation start for 1 and operation end for 2) means that the operation is common among manufacturers of the home appliances 2 of the type. This means that the operation corresponding to “basic operation” is available to all the home appliances 2 of the type of all the manufacturers supporting the voice operation service.

In contrast, the operation with a category name corresponding to one other than “basic operation” (for an AC, for example, smart stop for 3, hybrid operation setting for 4, high temperature monitoring for 5, low temperature monitoring for 6, and good sleeping monitoring for 7) means that the operation is an operation available to the home appliances 2 of the type of one of all the manufacturers, that is, an operation specific to that manufacturer.

The operation name 5412 stores an operation name. The operation name is a name of an operation corresponding to the operation number stored in the operation number 5410, and is also content of the voice originated from the user for performance of the operation. The setting content 5413 stores setting content. The setting content is content settable for the home appliances 2 at the time of the operation. The appliance operation information DB 541 is linked to the appliance operation information DB held by the appliance control device 6, for example, by the voice processing device 5 and the appliance control device 6 operating in cooperation with each other as appropriate by OAuth 2.0. This updates content of the appliance operation information DB 541.

With reference again to FIG. 5, the customer information DB 542 is a database where personal information of each customer who subscribes to a voice operation service is registered. The customer information DB 542 has registered information such as a name, an address, sex, a date of birth of each customer, an internet protocol (IP) address of the voice input/output device 3 installed at the customer's home (that is, the customer's house H), and the like.

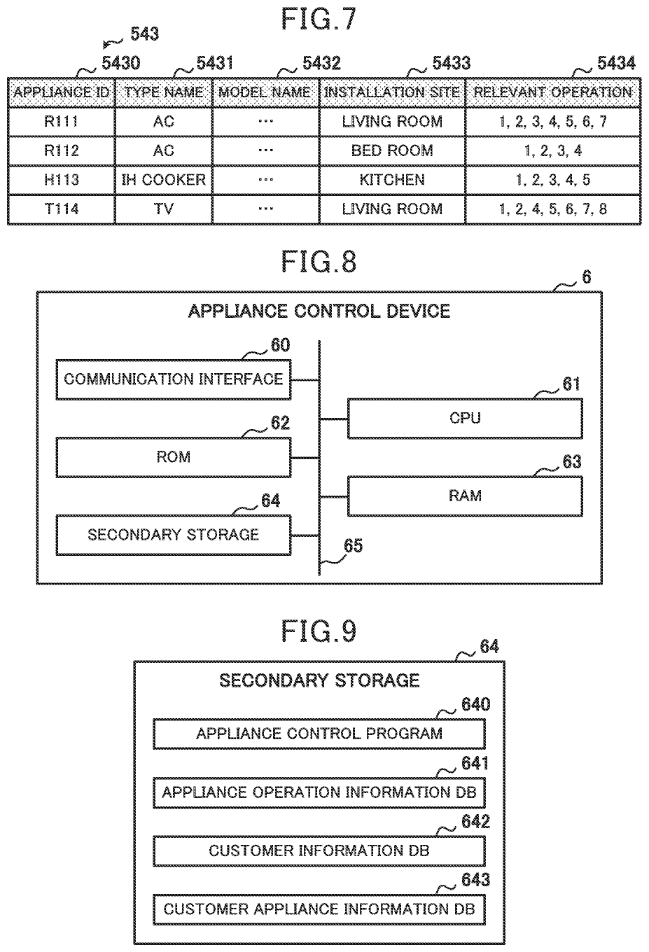

The customer appliance information DB 543 is a database where information relating to all the home appliances 2 installed at each customer's home is registered. Specifically, as illustrated in FIG. 7, the customer appliance information DB 543 has, for each customer, a record including items of an appliance ID 5430, a type name 5431, a model name 5432, an installation site 5433, a relevant operation 5434, and the like. The number of the records corresponds to the number of all the home appliances 2 installed in the customer's home.

The appliance ID 5430 stores an appliance ID of the home appliance 2. The appliance ID is an identification (ID) assigned for identifying each home appliance 2 in the voice operation service. The type name 5431 stores a name of the type (e.g., “AC”, “TV”, “1H cooker”, etc.) to which the home appliance 2 belongs. The model name 5432 stores a model name (also referred to as a model number) of the home appliance 2. The installation site 5433 stores a name indicating the installation site of the home appliance 2 (e.g., “living room”, “bedroom”, “kitchen”, etc.). The relevant operation 5434 stores an operation number of all the operations capable of being performed by the home appliance 2.

The customer information DB 542 and the customer appliance information DB 543 are linked to the customer information DB and the customer appliance information DB held by the appliance control device 6, for example, by the voice processing device 5 and the appliance control device 6 operating in cooperation with each other as appropriate by OAuth 2.0. This updates content of the customer information DB 542 and the customer appliance information DB 543.

Returning to FIG. 1, the appliance control device 6 is a server computer installed and operated by a manufacturer, a supplier, or the like of the home appliances 2, and is connected to the Internet. The appliance control device 6 achieves a voice operation for the home appliance 2 in cooperation with the voice processing device 5.

As illustrated in FIG. 8, the appliance control device 6 includes a communication interface 60, a CPU 61, a ROM 62, a RAM 63, and a secondary storage 64. These components are connected to one another via a bus 65.

The communication interface 60 is a device for communication with another device, such as the home gateway 4, the voice processing device 5, and the like, by connection to the Internet. The CPU 61 comprehensively controls the appliance control device 6. Functions of the appliance control device 6 achieved by the CPU 61 are described in detail later.

The ROM 62 stores firmware and data for use during execution of the firmware. The RAM 63 is used as a working area for the CPU 61.

The secondary storage 64 is a mass storage device including a readable and writable non-volatile semiconductor memory such as EEPROM, flash memory, or the like, or an HDD. As illustrated in FIG. 9, the secondary storage 64 stores an appliance control program 640, an appliance operation information DB 641, a customer information DB 642, and a customer appliance information DB 643.

The appliance control program 640 is a program for achieving a voice operation for the home appliance 2 in cooperation with the voice processing device 5. The appliance control program 640 has descriptions of processing for controlling, based on the operation information from the voice processing device 5, the corresponding home appliance 2, processing of sending to the voice processing device 5 result information indicating the result of controlling the home appliance 2, and the like.

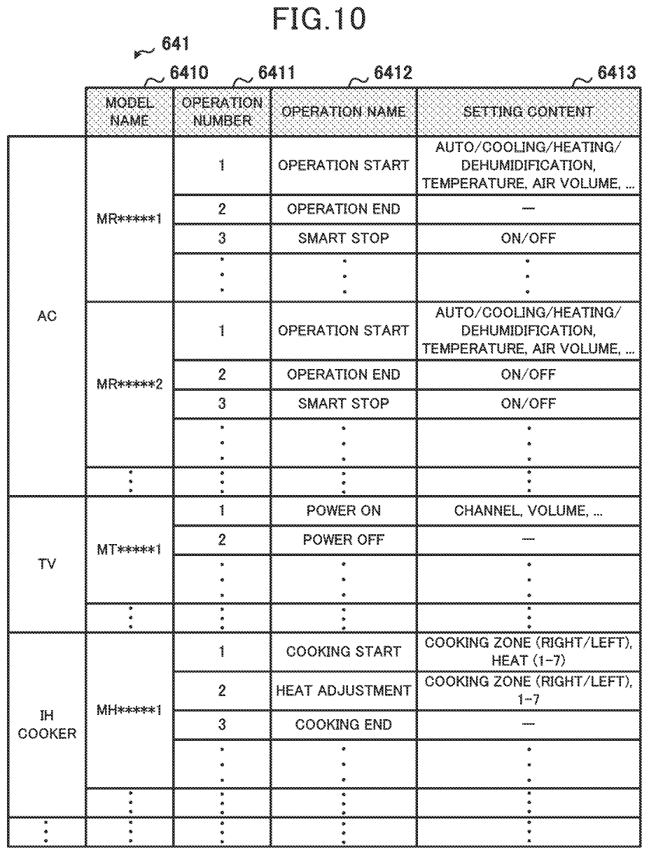

The appliance operation information DB 641 is a database in which information relating to the home appliance 2 of the manufacturer is recorded. Specifically, as illustrated in FIG. 10, the appliance operation information DB 641 has, for each of the types of the home appliances 2, registered records of items including a model name 6410, an operation number 6411, an operation name 6412, setting content 6413, and the like. The model name 6410 stores a model name of the home appliance 2. The operation number 6411 stores an operation number. The operation name 6412 stores an operation name corresponding to the operation number stored in the operation number 6411. The setting content 6413 stores setting content corresponding to the operation. The content of each record of the appliance operation information DB 641 may be automatically generated from data of an operation manual of the home appliance 2 of each type, for example, by an unillustrated DB creator, and may be set in each record.

As described above, the appliance operation information DB 641 of the appliance control device 6 is linked to the appliance operation information DB 541 of the voice processing device 5, for example, by the appliance control device 6 and the voice processing device 5 operating in cooperation with each other as appropriate by OAuth 2.0. This updates content of the appliance operation information DB 541 of the voice processing device 5.

Again with reference to FIG. 9, the customer information DB 642 is a database where personal information of each customer who is a purchaser of the home appliance 2 of the manufacturer and subscribes the voice operation service is recorded. The customer information DB 642 has registered information such as a name, an address, sex, a date of birth of each customer, and the like.

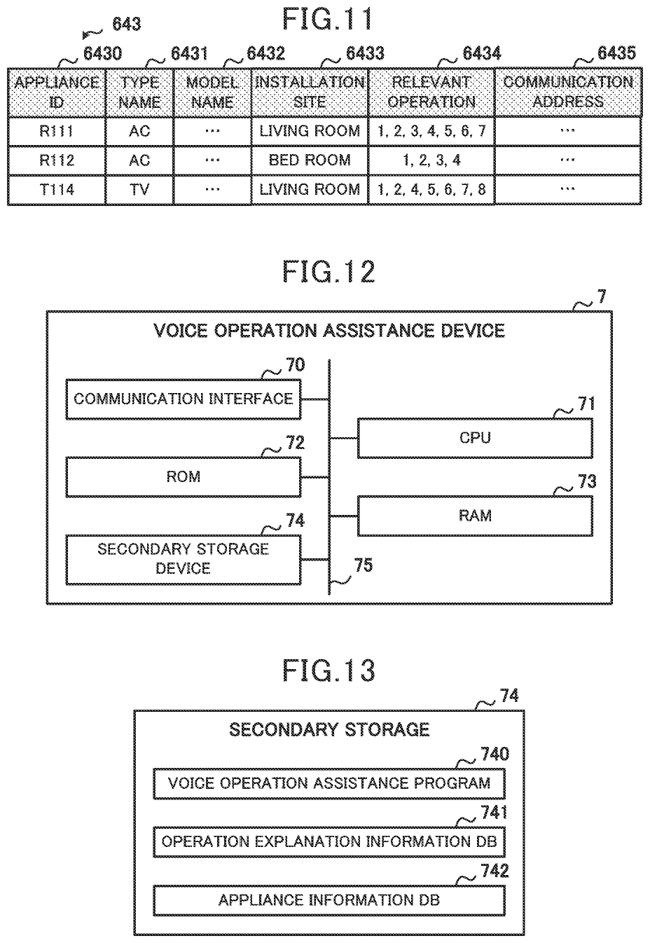

The customer appliance information DB 643 is a database where information relating to the home appliance 2 of the manufacturer installed at each customer's home is registered. Specifically, as illustrated in FIG. 11, the customer appliance information DB 643 has, for each customer, a record including items of an appliance ID 6430, a type name 6431, a model name 6432, an installation site 6433, a relevant operation 6434, a communication address 6435, and the like. The number of the records corresponds to the number of the home appliance 2 of the manufacturer installed in the customer's home.

The appliance ID 6430 stores an appliance ID assigned to the home appliance 2. The type name 6431 stores a name of the type to which the home appliance 2 belongs. The model name 6432 stores a model name of the home appliance 2. The installation site 6433 stores a name indicating the installation site of the home appliance 2. The relevant operation 6434 stores an operation number of all the operations operable relative to the home appliance 2. The communication address 6435 stores an IP address of the home appliance 2.

A user having purchased the home appliance 2 activates an application program (hereinafter referred to as a voice operation app) for utilizing the voice operation service installed beforehand in a smartphone, a tablet terminal, or the like, and performs a predetermined procedure (hereinafter, referred to as a registration procedure) for registering to the appliance control device 6 information relating to the user's personal information and the home appliance 2. The information relating to the user's personal information and the home appliance 2 of the user's home is thereby sent from the smartphone, the tablet terminal, or the like to the appliance control device 6. The above voice operation app can be downloaded from the appliance control device 6, another program distribution server, or the like to the smartphone, the tablet terminal, or the like.

In the above registration procedure, the type name, the model name, and the IP address are acquired from the home appliance 2 by communication via the home gateway 4 by the smartphone, the tablet terminal, or the like on which the above voice operation app runs.

As described above, the customer information DB 642 and the customer appliance information DB 643 of the appliance control device 6 are linked to the customer information DB 542 and the customer appliance information DB 543 of the voice processing device 5, for example, by the appliance control device 6 and the voice processing device 5 operating in cooperation with each other as appropriate by OAuth 2.0. This updates content of the customer information DB 542 and the customer appliance information DB 543 of the voice processing device 5.

With reference again to FIG. 1, the voice operation assistance device 7 is an example of the voice operation assistance device according to the present disclosure. The voice operation assistance device 7 is a server computer operated jointly by manufacturers approved for the voice operation service or operated by a third-party organization, and is connected to the Internet. The voice operation assistance device 7 achieves a voice operation assistance service in cooperation with the voice input/output device 3 and the voice processing device 5. As illustrated in FIG. 12, the voice operation assistance device 7 includes a communication interface 70, a CPU 71, a ROM 72, a RAM 73, and a secondary storage 74. These components are connected to one another via a bus 75.

The communication interface 70 is a device for communication with another device, such as the voice processing device 5, and the like, by connection to the Internet. The CPU 71 comprehensively controls the voice operation assistance device 7. Functions of the voice operation assistance device 7 achieved by the CPU 71 are described in detail later. The ROM 72 stores firmware and data for use at execution of the firmware. The RAM 73 is used as a working area for the CPU 71.

The secondary storage 74 is a mass storage device including a readable and writable non-volatile semiconductor memory such as EEPROM, flash memory, or the like, or an HDD. As illustrated in FIG. 13, the secondary storage 74 stores a voice operation assistance program 740, an operation explanation information DB 741, and an appliance information DB 742. The secondary storage 74 is an example of the storage according to the present disclosure.

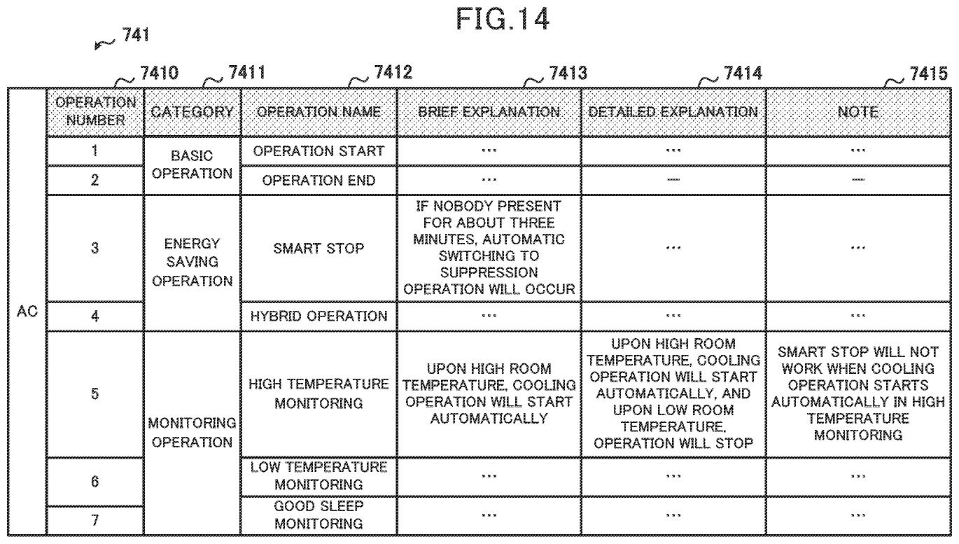

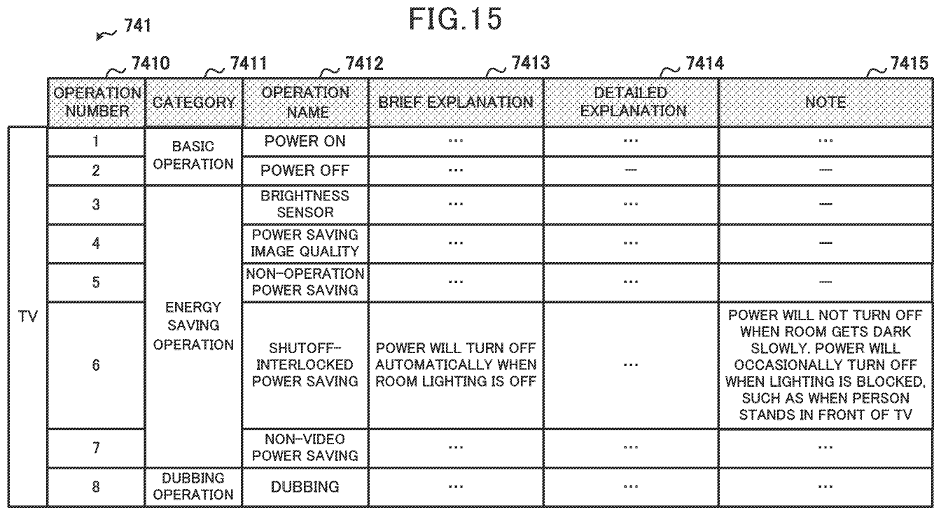

The voice operation assistance program 740 is a program with a description of processing relating to assisting of the voice operation. The operation explanation information DB 741 is a database where information for giving an explanation to a user about operations of each type of the home appliances 2 is recorded. Specifically, as illustrated in FIGS. 14 and 15, the operation explanation information DB 741 has, for each of the types of the home appliances 2, registered records of items including an operation number 7410, a category 7411, an operation name 7412, brief description 7413, detailed description 7414, notes 7415, and the like. The content of each record of the operation explanation information DB 741 may be automatically generated from data of an operation manual of the home appliance 2 of each type, for example, by an unillustrated DB creator, and may be set in each record.

The operation number 7410 stores an operation number. The category 7411 stores a category name corresponding to the operation number stored in the operation number 7410. The operation name 7412 stores an operation name corresponding to the operation number. The brief description 7413 stores information indicating brief description about the operation. The detailed description 7414 stores information indicating detailed description about the operation. The note 7415 stores information indicating matters to be noted about the operation.

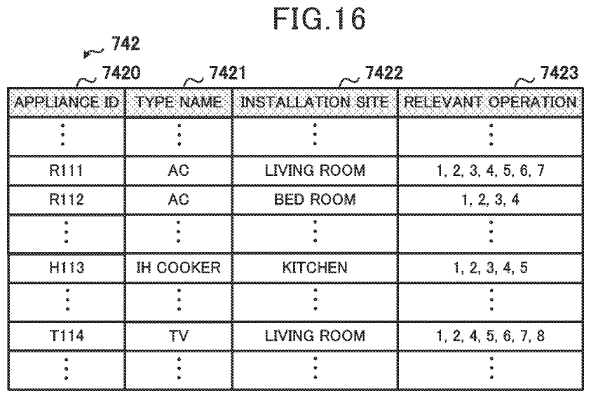

With reference again to FIG. 13, the appliance information DB 742 is a database where information relating to the home appliances 2 of all the customers is registered. Specifically, as illustrated in FIG. 16, the appliance information DB 742 has a record including items of an appliance ID 7420, a type name 7421, an installation site 7422, a relevant operation 7423, and the like. The number of the records corresponds to a total number of all the home appliances 2 installed in each customer's home.

The appliance ID 7420 stores an appliance ID assigned to the home appliance 2. The type name 7421 stores a name of the type to which the home appliance 2 belongs. The installation site 7422 stores a name indicating the installation site of the home appliance 2. The relevant operation 7423 stores an operation number of all the operations capable of being performed for the home appliance 2. The appliance information DB 742 is linked to the customer appliance information DB 643 held by the appliance control device 6, for example, by the voice operation assistance device 7 and the appliance control device 6 operating in cooperation with each other as appropriate by OAuth 2.0. This updates content of the appliance information DB 742.

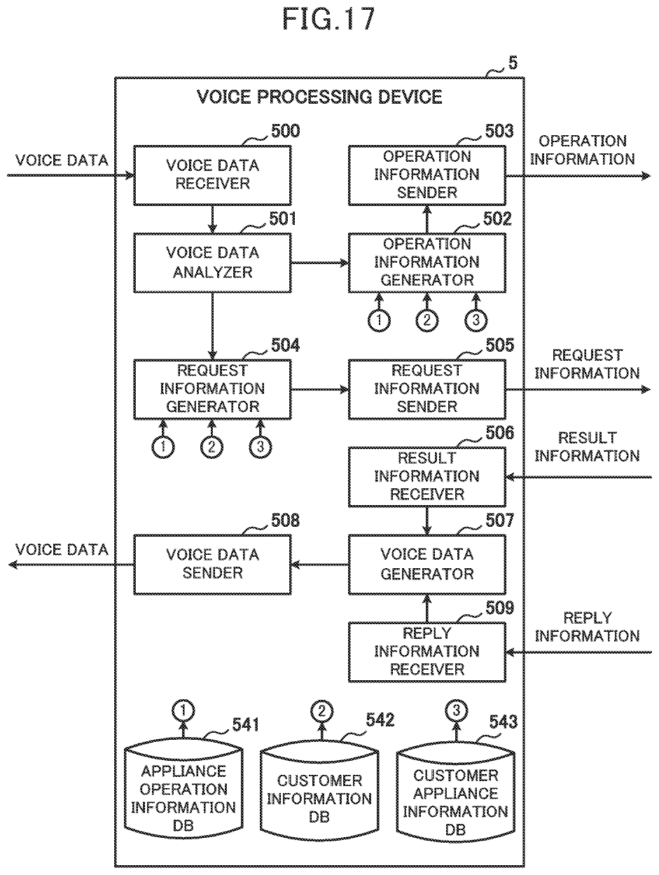

Next, functions of the voice processing device 5 are described. As illustrated in FIG. 17, the voice processing device 5 functionally includes a voice data receiver 500, a voice data analyzer 501, an operation information generator 502, an operation information sender 503, a request information generator 504, a request information sender 505, a result information receiver 506, a voice data generator 507, a voice data sender 508, and a reply information receiver 509. These functional components are achieved by the CPU 51 executing the voice processing program 540 stored in the secondary storage 54.

The voice data receiver 500 is an example of voice data receiving means according to the present disclosure. The voice data receiver 500 receives voice data sent via the home gateway 4 from the voice input/output device 3. The voice data is an example of first voice data according to the present disclosure. The voice data analyzer 501 analyzes the voice data received by the voice data receiver 500 and generates text data (hereinafter referred to as voice content data) indicating utterance content of a user. When the generated voice content data indicates an operation relative to the home appliance 2, the voice data analyzer 501 supplies the voice content data to the operation information generator 502. In contrast, when the generated voice content data indicates an inquiry about the operation of the home appliance 2, the voice data analyzer 501 supplies the voice content data to the request information generator 504.

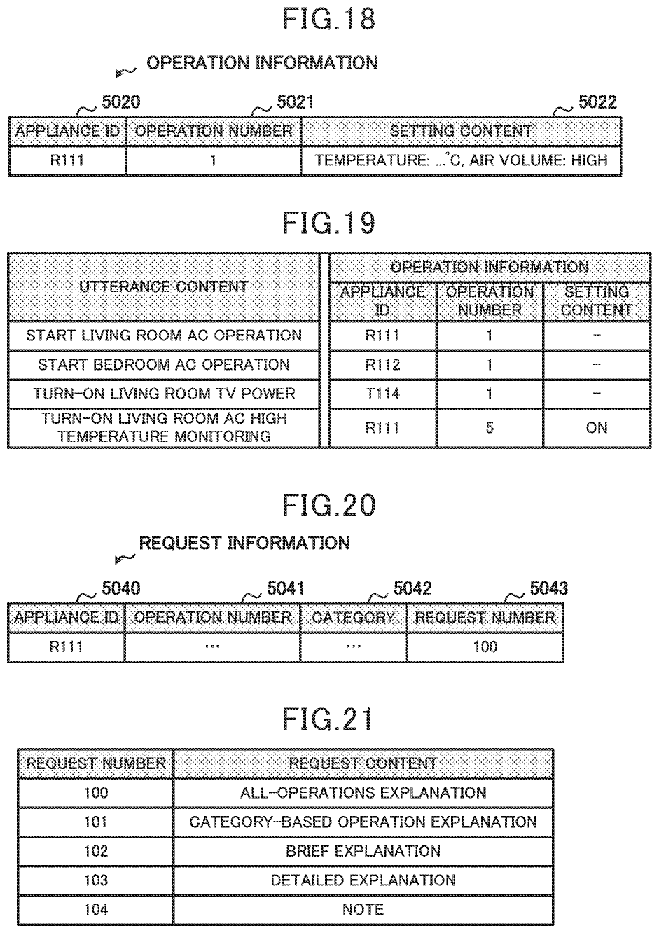

The operation information generator 502 generates operation information based on the voice content data supplied from the voice data analyzer 501, the appliance operation information DB 541, the customer information DB 542, and the customer appliance information DB 543. As illustrated in FIG. 18, the operation information has items including an appliance ID 5020, an operation number 5021, setting content 5022, and the like. The appliance ID 5020 stores the appliance ID of the home appliance 2 that is to be a target. The operation number 5021 stores an operation number corresponding to the operation that is to be a target. The setting content 5022 stores setting content as instructed by the user for the operation.

The operation information generator 502 identifies, from keywords each indicating sites and types included in the voice content data, the home appliance 2 that is the target of the voice operation at the customer's home. For example, when the voice content data includes “living room” and “AC”, the operation information generator 502 identifies that the home appliance 2 with the appliance ID “R111” is the home appliance 2 that is a target of the voice operation.

The operation information generator 502 identifies the operation number and/or setting content, based on the appliance ID of the identified home appliance 2, and the keywords indicating the operation name and/or setting content (e.g., “operation start”, “operation end”, “power on”, “power off”. “high temperature monitoring on”, etc.) included in the voice content data. FIG. 19 illustrates an example of a correspondence relationship between utterance content of a user and operation information to be generated.

The operation information sender 503 sends to the appliance control device 6 the operation information generated by the operation information generator 502.

The request information generator 504 generates request information based on the voice content data supplied from the voice data analyzer 501, the appliance operation information DB 541, the customer information DB 542, and the customer appliance information DB 543. As illustrated in FIG. 20, the request information has items including an appliance ID 5040, an operation number 5041, a category 5042, a request number 5043, and the like. The appliance ID 5040 stores the appliance ID of the home appliance 2 that is to be a target. The operation number 5041 stores an operation number corresponding to the operation that is to be a target. However, in a case of an inquiry of not specifying the operation, the operation number 5041 stores predetermined dummy data.

The category 5042 stores a category name that is to be a target. However, in a case of an inquiry that does not specify the category, the category 5042 stores predetermined dummy data. The request number 5043 stores a request number. As illustrated in FIG. 21, the request number is a number assigned uniquely to each request content.

The request information generator 504 identifies, from keywords each indicating sites and types included in the voice content data, the home appliance 2 that is to be a target of the inquiry at the customer's home. For example, when the voice content data includes “living room” and “AC”, the request information generator 504 identifies that the home appliance 2 with the appliance ID being “R111” is the home appliance 2 that is to be a target of the inquiry. The request information generator 504 stores the identified appliance ID in the appliance ID 5040.

The request information generator 504 determines whether the keyword indicating the operation name or the category name exists in the voice content data. When a keyword of either name does not exist, the request information generator 504 stores “100” in the request number 5043. The request information generator 504 also stores dummy data in the operation number 5041 and the category 5042.

When the keyword indicating the category name exists in the voice content data, the request information generator 504 stores “101” in the request number 5043. The request information generator 504 also stores dummy data in the operation number 5041, and stores in the category 5042 the keyword indicating the category name.

When the keyword indicating the operation name exists in the voice content data, the request information generator 504 identifies the operation number based on the appliance ID of the identified home appliance 2 and the operation name. The request information generator 504 stores the identified operation number in the operation number 5041. The request information generator 504 determines whether “details” or “notes” exists in the voice content data. When neither one exists, the request information generator 504 stores “102” in the request number 5043 and stores dummy data in the category 5042.

When “details” exist in the voice content data, the request information generator 504 stores “103” in the request number 5043 and stores dummy data in the category 5042. When “notes” exist in the voice content data, the request information generator 504 stores “104” in the request number 5043 and stores dummy data in the category 5042.

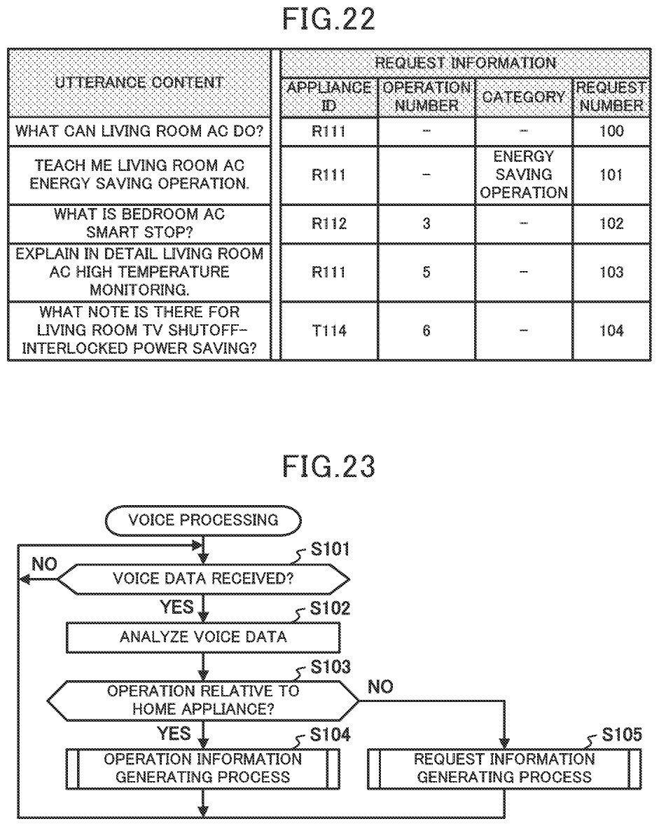

The request information generator 504 thus generates the request information corresponding to the user's utterance content. FIG. 22 illustrates an example of a correspondence relationship between utterance content of a user and request information to be generated.

The request information sender 505 sends to the voice operation assistance device 7 request information generated by the request information generator 504. The request information generator 504 and the request information sender 505 are examples of reply request means according to the present disclosure.

The result information receiver 506 receives result information from the appliance control device 6. The result information is information indicating whether the targeted home appliance 2 have normally operated based on the operation information sent previously. The result information receiver 506 supplies the received result information to the voice data generator 507. The voice data generator 507 generates, based on the result information supplied from the result information receiver 506, voice data by known voice synthesis processing, and supplies the generated voice data to the voice data sender 508. The voice data is an example of second voice data according to the present disclosure. The voice data sender 508 sends to the voice input/output device 3 the voice data supplied from the voice data generator 507. The voice data sender 508 is an example of voice data sending means according to the present disclosure.

The reply information receiver 509 receives reply information from the voice operation assistance device 7. The reply information is information generated by the voice operation assistance device 7 in response to the request information sent previously, and the reply information indicates a reply to an inquiry of a user. The reply information receiver 509 supplies the received reply information to the voice data generator 507. The voice data generator 507 generates, based on the reply information supplied from the reply information receiver 509, voice data by known voice synthesis processing, and supplies the generated voice data to the voice data sender 508. The voice data sender 508 sends to the voice input/output device 3 the voice data supplied from the voice data generator 507.

FIG. 23 is a flowchart illustrating steps of voice processing executed by the voice processing device 5. Upon the voice data receiver 500 receiving the voice data sent from the voice input/output device 3 (Yes in step S101), the voice data analyzer 501 analyzes the voice data (step S102) and generates the voice content data.

When the voice content data generated by the voice data analyzer 501 indicates an operation relative to the home appliance 2 (Yes in step S103), the voice processing device 5 executes the operation information generating processing (step S104). By contrast, when the above voice content data does not indicate the operation relative to the home appliance 2, that is, indicates an inquiry about the operation of the home appliance (No m step S103), the voice processing device 5 executes the request information generating process (step S105).

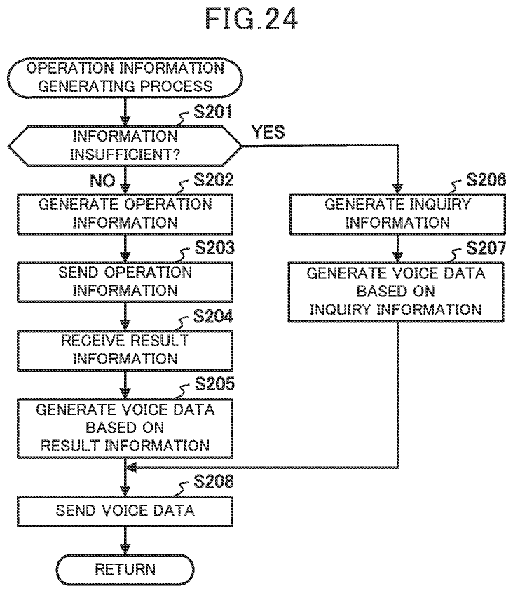

FIG. 24 is a flowchart illustrating steps of an operation information generating process. The operation information generator 502 determines whether or not information necessary for generation of the operation information is insufficient in the voice content data generated by the voice data analyzer 501 (step S201).

For example, when the voice content data does not include any one of the keyword indicating the type of the home appliance 2 that is to be a target and the keyword indicating the installation site thereof, the operation information generator 502 determines that the necessary information is insufficient.

When the necessary information is not insufficient (No in step S201), the operation information generator 502 generates operation information as described above (step S202). The operation information sender 503 sends to the appliance control device 6 the operation information generated by the operation information generator 502 (step S203).

The result information receiver 506 receives the result information from the appliance control device 6 (step S204). The voice data generator 507 generates voice data based on the result information received by the result information receiver 506 (step S205).

By contrast, when the necessary information is insufficient (Yes in step S201), the operation information generator 502 generates inquiry information for inquiring the user for the insufficient information (step S206). For example, the inquiry information includes text data, such as “Which is the operation target AC, the one in the living room or in the bedroom?”.

The voice data generator 507 generates voice data based on the inquiry information generated by the operation information generator 502 (step S207).

The voice data sender 508 sends to the voice input/output device 3 the voice data generated by the voice data generator 507 (step S208). Then the processing returns to steps S101 of the flowchart of FIG. 23.

When the voice data based on the inquiry information is sent to the voice input/output device 3, the voice processing device 5, upon obtaining a reply indicating supplemental information from a user, generates operation information based on the supplementary information and the previously generated voice content data, and sends the generated operation information to the appliance control device 6.

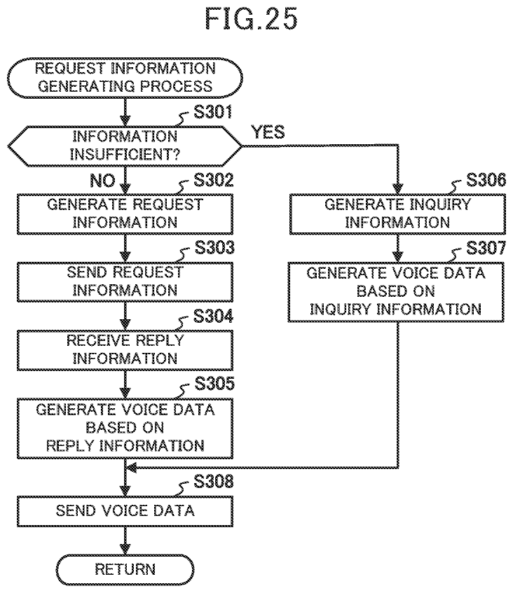

FIG. 25 is a flowchart illustrating steps of a request information generating process. The request information generator 504 determines whether or not information necessary for generation of the request information is insufficient in the voice content data generated by the voice data analyzer 501 (step S301).

For example, when the voice content data does not include any one of the keyword indicating the type of the home appliance 2 that is to be a target and the keyword indicating the installation site thereof, the request information generator 504 determines that the necessary information is insufficient.

When the necessary information is not insufficient (No in step S301), the request information generator 504 generates request information as described above (step S302). The request information sender 505 sends to the voice operation assistance device 7 request information generated by the request information generator 504 (step S303).

The reply information receiver 509 receives reply information from the voice operation assistance device 7 (step S304). The voice data generator 507 generates voice data based on the reply information received by the reply information receiver 509 (step S305).

By contrast, when the necessary information is insufficient (Yes in step S301), the request information generator 504 generates inquiry information for inquiring the user for the insufficient information (step S306). For example, the inquiry information includes text data, such as “About which AC did you inquire, the one in the living room or in the bedroom?”.

The voice data generator 507 generates voice data based on the inquiry information generated by the request information generator 504 (step S307).

The voice data sender 508 sends to the voice input/output device 3 the voice data generated by the voice data generator 507 (step S308). Then the processing returns to steps S101 of the flowchart of FIG. 23.

When the voice data based on the inquiry information is sent to the voice input/output device 3, the voice processing device 5, upon obtaining a reply indicating supplemental information from the user, generates request information based on the supplementary information and the previously generated voice content data, and sends the generated request information to the voice operation assistance device 7.

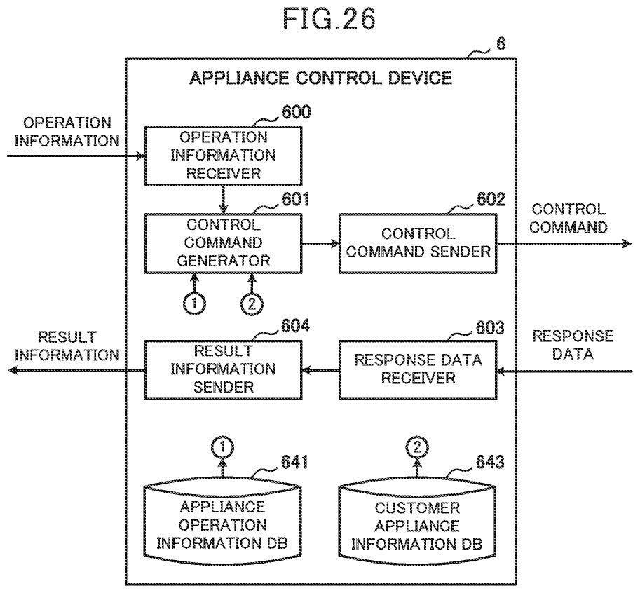

Next, functions of the appliance control device 6 are described. As illustrated in FIG. 26, the appliance control device 6 functionally includes an operation information receiver 600, a control command generator 601, a control command sender 602, a response data receiver 603, and a result information sender 604. These functional components are achieved by the CPU 61 executing the appliance control program 640.

The operation information receiver 600 receives the operation information (see FIG. 18) sent from the voice processing device 5. The control command generator 601 generates a control command for controlling the target home appliance 2 based on the operation information received by the operation information receiver 600, the appliance operation information DB 641, and the customer appliance information DB 643. The control command sender 602 sends to the home appliance 2 the control command generated by the control command generator 601. The control command generator 601 is an example of control command generating means according to the present disclosure, and the control command sender 602 is an example of control command sending means according to the present disclosure.

After the control command sender 602 sends the control command, the response data receiver 603 receives response data sent from the destination home appliance 2. Such response data includes information indicating whether or not an action has been taken in accordance with the control command. When the response data includes information indicating that the action has been taken in accordance with the control command, the response data receiver 603 notifies the result information sender 604 that the home appliance 2 has been normally operated.

By contrast, when the response data includes information indicating that the action has not been taken in accordance with the control command, the response data receiver 603 notifies the result information sender 604 that the home appliance 2 is not normally operated. In addition, in a case of inability to receive the response data from the home appliance 2 even upon passage of a predetermined time since sending of the control command to the home appliance 2, the response data receiver 603 notifies the result information sender 604 that the home appliance 2 is not operating normally.

The result information sender 604 sends to the voice processing device 5 the result information corresponding to the content given by the response data receiver 603 as notification.

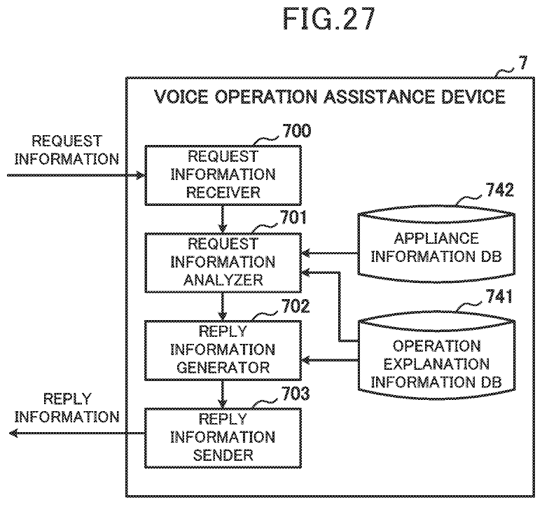

Next, functions of the voice operation assistance device 7 are described. As illustrated in FIG. 27, the voice operation assistance device 7 functionally includes a request information receiver 700, a request information analyzer 701, a reply information generator 702, and a reply information sender 703. These functional components are achieved by the CPU 71 executing the aforementioned voice operation assistance program 740.

The request information receiver 700 receives request information (see FIG. 20) sent from the voice processing device 5. The request information analyzer 701 analyzes the request information received by the request information receiver 700 with reference to the operation explanation information DB 741 and the appliance information DB 742. Specifically, the request information analyzer 701 retrieves data stored in each of the appliance ID 5040, the operation number 5041, the category 5042, and the request number 5043 of the request information. The request information analyzer 701 acquires, with reference to the appliance information DB 742, all the operation numbers corresponding to the home appliance 2 with the appliance ID stored in the appliance ID 5040.

The request information analyzer 701 supplies to the reply information generator 702 analysis result information including each of the retrieved data (dummy data excluded) and all the acquired operation numbers. The request information analyzer 701 checks correctness or incorrectness of inquiry content indicated by the request information, and notifies the reply information generator 702 of the check result. Specifically, when the operation number is stored in the operation number 5041, the request information analyzer 701 checks whether the operation number corresponds to the home appliance 2. When the operation number corresponds to the home appliance 2, the request information analyzer 701 notifies the reply information generator 702 of the check result indicating that the inquiry content is correct. By contrast, when the operation number does not correspond to the home appliance 2, the request information analyzer 701 notifies the reply information generator 702 of the check result indicating the inquiry content is incorrect.

When the category name is stored in the category 5042, the request information analyzer 701 checks, with reference to the operation explanation information DB 741, whether or not the category name corresponds to the home appliance 2. When the category name corresponds to the home appliance 2, the request information analyzer 701 notifies the reply information generator 702 of the check result indicating that the inquiry content is correct. By contrast, when the category name does not correspond to the home appliance 2, the request information analyzer 701 notifies the reply information generator 702 of the check result indicating the inquiry content is incorrect.

When the dummy data is stored in both of the operation number 5041 and the category 5042, the request information analyzer 701 checks whether “100” is stored in the request number 5043. When “100” is stored in the request number 5043, that is, the request content is “all-operations description”, the request information analyzer 701 notifies the reply information generator 702 of the check result indicating that the inquiry content is correct. By contrast, when the request number other than “100” is stored in the request number 5043, that is, the request content is content other than “all-operations description”, the request information analyzer 701 notifies the reply information generator 702 of the check result indicating that the inquiry content is incorrect.

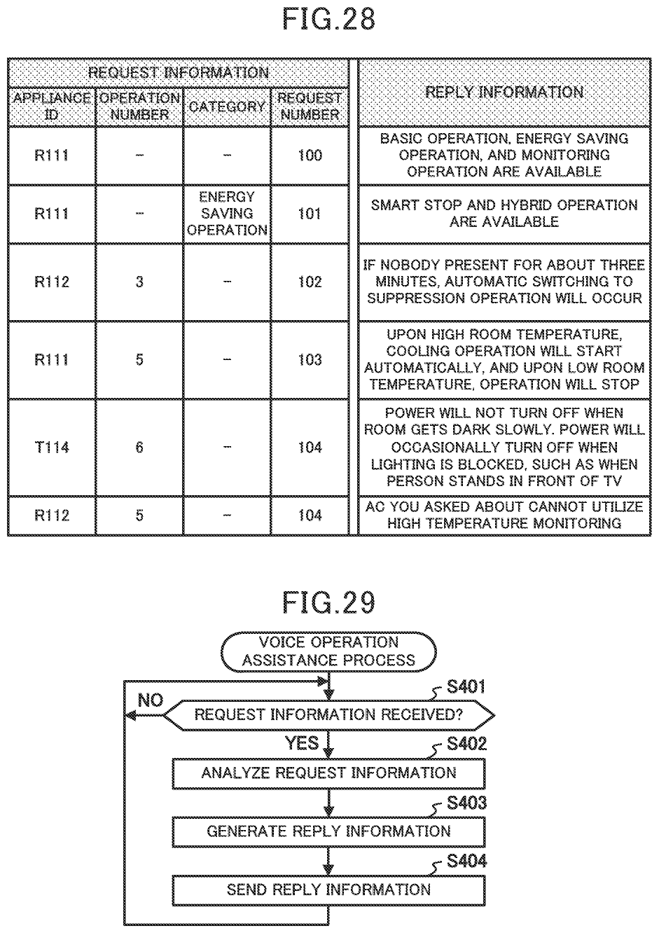

The reply information generator 702 is an example of reply information generating means according to the present disclosure. The reply information generator 702 generates reply information indicating a reply to the user's inquiry based on the analysis result information supplied from the request information analyzer 701, the check result given by the request information analyzer 701 as notification, and the operation explanation information DB 741. FIG. 28 illustrates an example of a correspondence relationship between request information and reply information to be generated.

The reply information sender 703 sends to the voice processing device 5 the reply information generated by the reply information generator 702. The reply information generator 702 and the reply information sender 703 are examples of reply means according to the present disclosure.

FIG. 29 is a flowchart illustrating steps of the voice operation assistance process executed by the voice operation assistance device 7. Upon the request information receiver 700 receiving the request information sent from the voice processing device 5 (Yes in step S401), the request information analyzer 701 analyzes the request information (step S402).

The request information analyzer 701 supplies to the reply information generator 702 the analysis result information including each data except the dummy data retrieved from the request information and all the operation numbers corresponding to the home appliance 2 indicated by the request information. The request information analyzer 701 notifies the reply information generator 702 of the check result indicating correctness or incorrectness of the inquiry content indicated by the request information.

The reply information generator 702 generates the reply information based on the analysis result information supplied from the request information analyzer 701, the check result given by the request information analyzer 701 as notification, and the operation explanation information DB 741 (step S403).

The reply information sender 703 sends to the voice processing device 5 the reply information generated by the reply information generator 702 (step S404).

As described above, according to the voice operation assistance system according to Embodiment 1, the voice processing device 5 retains the appliance operation information DB 541 where information relating to all the operations corresponding to the types is registered for each type of the home appliances 2. Thus, regardless of differences in manufacturers or categories of the operations, formats of the operation information to be sent to the appliance control device 6 can be in common and participation by more manufacturers in the voice operation service can be expected.

The voice operation assistance device 7 retains the operation explanation information DB 741 where information for giving an explanation to the user about operations for each type of the home appliances 2 is registered. Upon receiving from the user via the voice processing device 5 an inquiry about an operation of the home appliance 2 installed at house H of the user, the voice operation assistance device 7 generates reply information for an audio reply to the inquiry. Thus the user can easily perform a manufacturer-specific operation of the home appliance 2 rather than merely a basic operation common among the manufacturers. As a result, the user can sufficiently utilize the home appliances 2 that the user has. Providing service that sufficiently utilizes the home appliances 2 can promote sales of the home appliances 2.

Instead of the voice operation assistance device 7, the voice processing device 5 may have capabilities equivalent to the voice operation assistance device 7, or the appliance control device 6 may have capabilities equivalent to the voice operation assistance device 7.

The voice processing device 5, the appliance control device 6, and the voice operation assistance device 7 may be implemented as a single device.

### Embodiment 2

Next, Embodiment 2 of the present disclosure is described. In the following description, components and the like that are common to those of Embodiment 1 are given the same reference numerals, and descriptions thereof are omitted.

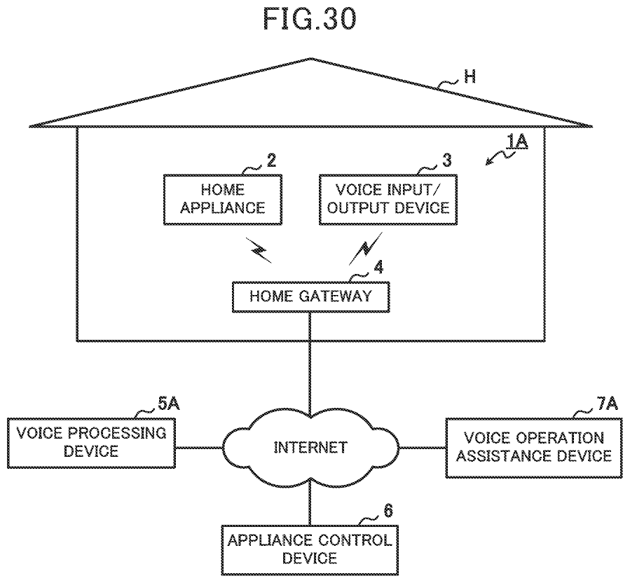

FIG. 30 is a diagram illustrating an overall configuration of a voice operation system 1A including a voice operation assistance system according to Embodiment 2 of the present disclosure. The voice operation system 1A includes one or more home appliances 2, a voice input/output device 3, a home gateway 4, a voice processing device 5A, an appliance control device 6, and a voice operation assistance device 7A. The voice operation assistance system according to Embodiment 2 includes the voice input/output device 3, the home gateway 4, the voice processing device 5A, and the voice operation assistance device 7A.

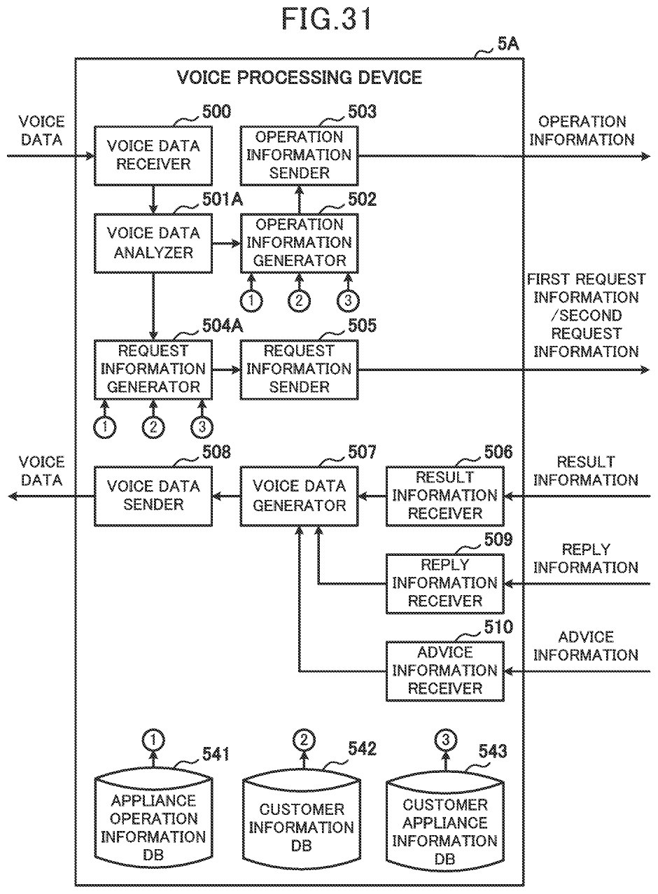

The hardware configuration of the voice processing device 5A is similar to that of the voice processing device 5 of Embodiment 1 (see FIG. 4). As illustrated in FIG. 31, the voice processing device 5A functionally includes a voice data receiver 500, a voice data analyzer 501A, an operation information generator 502, an operation information sender 503, a request information generator 504A, a request information sender 505, a result information receiver 506, a voice data generator 507, a voice data sender 508, a reply information receiver 509, and an advice information receiver 510.

The voice data analyzer 501A executes processing similar to the voice data analyzer 501 of the voice processing device 5 of Embodiment 1. That is, the voice data analyzer 501A analyzes the voice data received from the voice data receiver 500, thereby generating voice content data indicating utterance content of a user. When the generated voice content data indicates an operation relative to the home appliance 2, the voice data analyzer 501A supplies the voice content data to the operation information generator 502.

In addition, when the generated voice content data indicates an inquiry about an operation of the home appliance 2 or a request for advice about an operation of the home appliance 2, the voice data analyzer 501A supplies the voice content data to the request information generator 504A.

When the voice content data supplied from the voice data analyzer 501A indicates an inquiry about the operation of the home appliance 2, the request information generator 504A generates first request information for requesting a reply to the inquiry based on the voice content data, the appliance operation information DB 541, the customer information DB 542, and the customer appliance information DB 543, similarly to the request information generator 504 of the voice processing device 5 of Embodiment 1. The format of this first request information is similar to the request information generated by the request information generator 504 in Embodiment 1 (see FIG. 20).

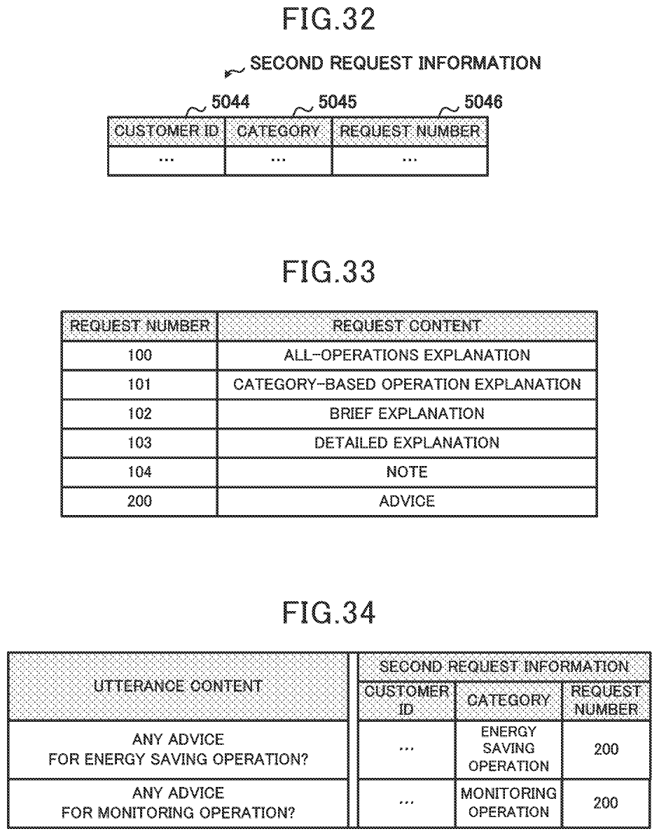

When the voice content data supplied from the voice data analyzer 501A indicates a request for advice about an operation of the home appliance 2, the request information generator 504A generates, based on the voice content data, second request information for requesting advice about an operation of the home appliance 2 at the user's home. As illustrated in FIG. 32, the second request information has items including a customer ID 5044, a category 5045, a request number 5046, and the like. The customer ID 5044 stores the customer ID of the user. The customer ID is an ID assigned for identifying each customer in the voice operation service.

The category 5045 stores a category name that is to be a target. The request number 5046 stores a request number. A relationship between the request number and the request content in the present embodiment is illustrated in FIG. 33. FIG. 34 illustrates an example of a correspondence relationship between utterance content of a user and second request information to be generated. The request information sender 505 sends to the voice operation assistance device 7A the first request information or the second request information generated by the request information generator 504A.

The advice information receiver 510 receives the advice information from the voice operation assistance device 7A. The advice information is information generated by the voice operation assistance device 7A in response to the second request information sent previously and is also information indicating advice about an operation of the category specified by the user. The advice information receiver 510 supplies the received advice information to the voice data generator 507. The voice data generator 507 generates, based on the advice information supplied from the advice information receiver 510, voice data by known voice synthesis processing, and supplies the generated voice data to the voice data sender 508. The voice data is an example of third voice data according to the present disclosure. The voice data sender 508 sends to the voice input/output device 3 the voice data supplied from the voice data generator 507.

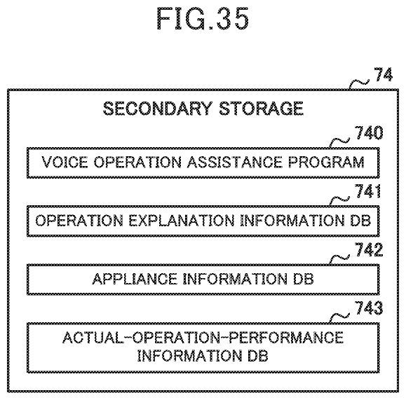

Next, the voice operation assistance device 7A is described. The hardware configuration of the voice operation assistance device 7A is similar to that of the voice operation assistance device 7 of Embodiment 1 (see FIG. 12). However, the secondary storage 74 of the voice operation assistance device 7A further stores actual-operation-performance information DB 743, as illustrated in FIG. 35. The actual-operation-performance information DB 743 is a database where information relating to actual operation performance of all the home appliances 2 installed at each customer's home is registered. The actual-operation-performance information DB 743 is created, based on the operation explanation information DB 741 and the appliance information DB 742, by an unillustrated DB creator.

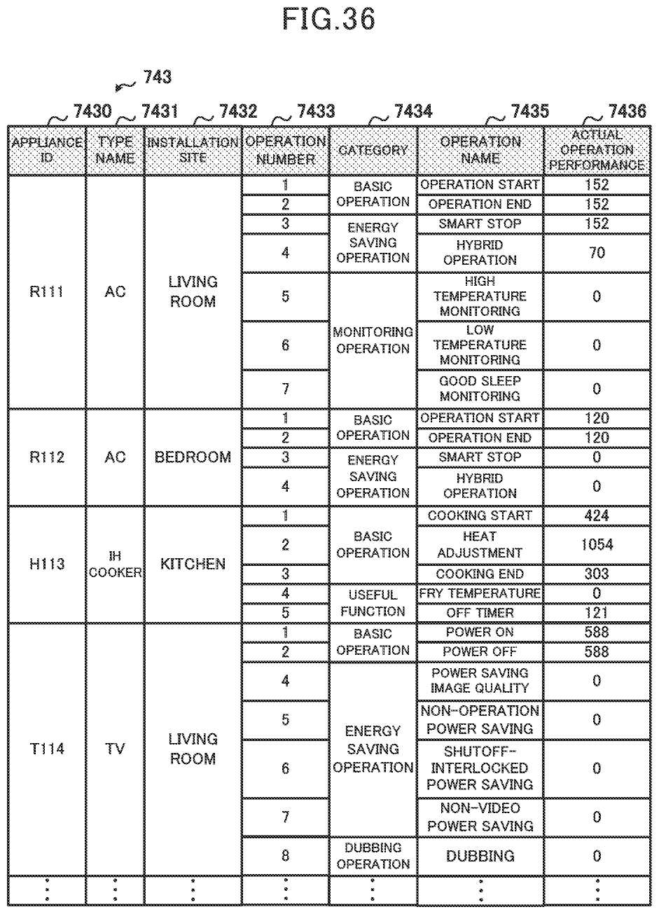

Specifically, as illustrated in FIG. 36, the actual-operation-performance information DB 743 has, for each customer, a record including items that are an appliance ID 7430, a type name 7431, an installation site 7432, an operation number 7433, a category 7434, an operation name 7435, an actual operation performance 7436, and the like. The number of the records corresponds to the number of all the home appliances 2 installed in the customer's home.

The appliance ID 5430 stores an appliance ID of the home appliance 2. The type name 7431 stores a name of a type to which the home appliance 2 belongs. The installation site 7432 stores a name indicating the installation site of the home appliance 2. The operation number 7433 stores an operation number. The category 7434 stores a category name corresponding to the operation number stored in the operation number 7433. The operation name 7435 stores an operation name corresponding to the operation number stored in the operation number 7433.

The actual operation performance 7436 stores the actual performance of the operation. Specifically, the actual operation performance 7436 stores the number of operations in the past one year of the operation. For example, the voice processing device 5A sends to the voice operation assistance device 7A actual-operation-performance notification having the appliance ID and the operation number included in the operation information every time upon sending the operation information to the appliance control device 6. Upon reception of the actual-operation-performance notification from the voice processing device 5A, the voice operation assistance device 7A increments the number of operations stored in the actual operation performance 7436 of the record corresponding to the actual-operation-performance notification in the actual-operation-performance information DB 743. Alternatively, the voice operation assistance device 7A may update the actual-operation-performance information DB 743 by receiving notification similar to the above actual-operation-performance notification from the appliance control device 6.

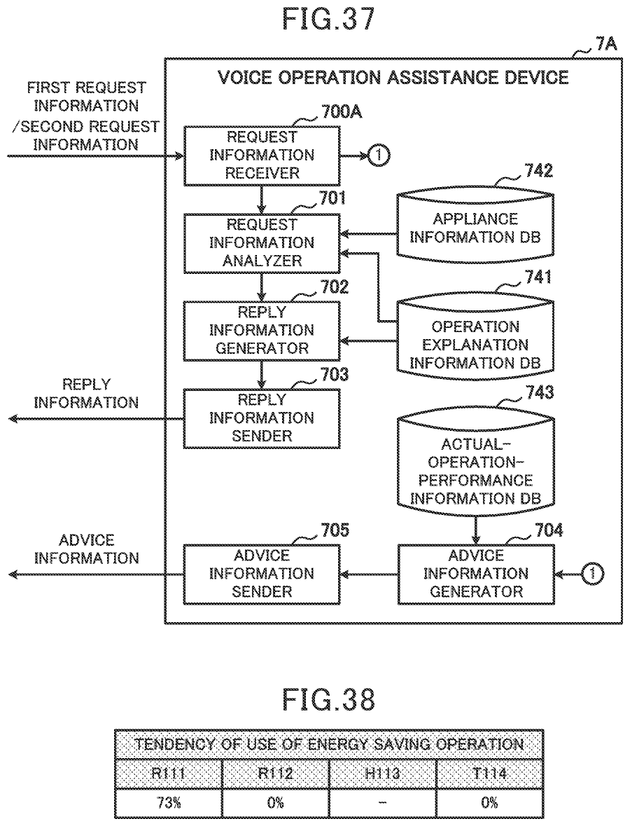

As illustrated in FIG. 37, the voice operation assistance device 7A functionally includes a request information receiver 700A, a request information analyzer 701, a reply information generator 702, a reply information sender 703, an advice information generator 704, and an advice information sender 705.

The request information receiver 700A receives the first request information (see FIG. 20) or the second request information (see FIG. 32) sent from the voice operation assistance device 7A. The request information receiver 700A supplies the received first request information to the request information analyzer 701 and supplies the received second request information to the advice information generator 704.

The advice information generator 704 is an example of advice information generating means according to the present disclosure. The advice information generator 704 generates the advice information based on the second request information and the actual-operation-performance information DB 743. Specifically, for each home appliance 2 installed at the customer's home, the advice information generator 704 first calculates a tendency of use of the operation with a specified category name by the following equation 1.

Tendency of use (%)=(average number of operations of the operation with category name of interest)(number of operations of the operation with an operation number in basic operation being “1”) (equation 1)

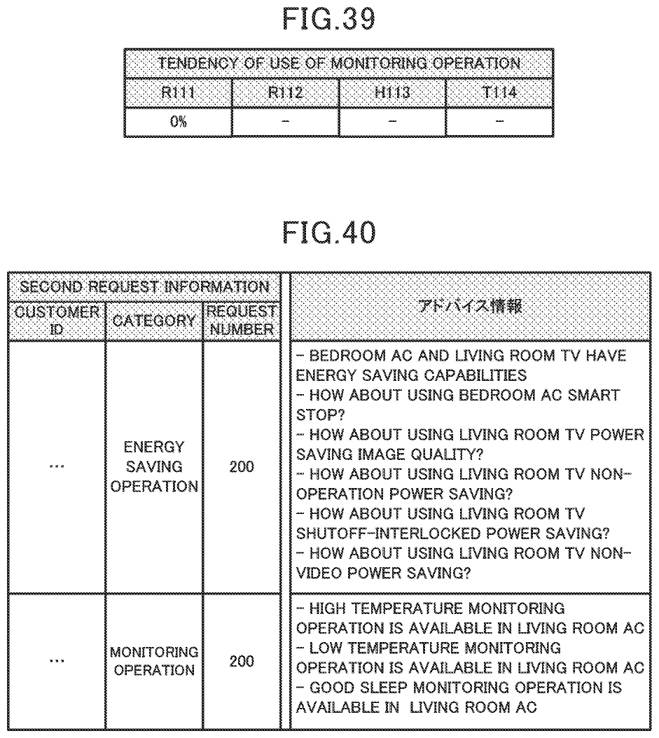

FIG. 38 is an example of a tendency of use in “energy saving operation”, and FIG. 39 is an example of a tendency of use in “monitoring operation”.

The advice information generator 704 selects, based on the calculated tendency of use, a home appliance 2 (hereinafter referred to as an advice target) that is to be an advice target. For example, when the category name specified by the user is “energy saving operation”, the advice information generator 704 selects as the advice target, among all the home appliances 2 at the user's home, a home appliance 2 having a tendency of use that is less than 50%.

For example, when the category name specified by the user is “monitoring operation”, the advice information generator 704 selects as the advice target, among all the home appliances 2 at the user's home, a home appliance 2 having a tendency of use of “monitoring operation” that is less than 20%.

Then the advice information generator 704 generates the advice information based on the selected advice target and the category name specified by the user. FIG. 40 is an example of a correspondence relationship between second request information and advice information to be generated.

As described above, according to the voice operation assistance system according to Embodiment 2, the voice operation assistance device 7A generates advice information for audio announcement of advice about an operation with the category specified by the user. As a result, the user can sufficiently utilize the home appliances 2 that the user has.

In the above embodiment, the advice information generator 704 of the voice operation assistance device 7A determines necessity or unnecessity of advice by managing the number of operations in the past one year in each of the operations of the home appliances 2, but the length of the period for management of the number of operations is a freely-selected matter of design.

When the home appliances 2 that are made by the same manufacturer and have the same type but a different model name are installed at a house H and at least one of the operations under the categories other than the basic operation is common among the home appliances 2, the advice information generator 704 may determine necessity or unnecessity of advice in light of a status of usage of the common operation in another home appliance. For example, as illustrated in FIG. 36, the AC in the living room with the appliance ID of R111 and the AC in the bedroom with the appliance ID of R112 have the energy saving operation in common. However, the AC in the living room has an actual performance of the energy saving operation in the past one year, while the AC in the bedroom does not an actual performance of the energy saving operation in the past one year.

In the above case, irrespective of the status of use of the energy saving operation for the AC in the bedroom, the advice information generator 704 preferably does not generate the advice information relating to the energy saving operation. This is because the actual usage performance of the energy saving operation of the AC in the living room shows that the user has knowledge of the energy saving operation of the AC. Such determination on the necessity or unnecessity of advice enables proper advice to be given to the user.

Instead of the voice operation assistance device 7A, the voice processing device 5A may have capabilities equivalent to the voice operation assistance device 7A, or the appliance control device 6 may have capabilities equivalent to the voice operation assistance device 7A.

The voice processing device 5A, the appliance control device 6, and the voice operation assistance device 7A may be implemented as a single device.

### Embodiment 3

Next, Embodiment 3 of the present disclosure is described. In the following description, components and the like that are common to those of Embodiment 1 are given the same reference numerals, and descriptions thereof are omitted.

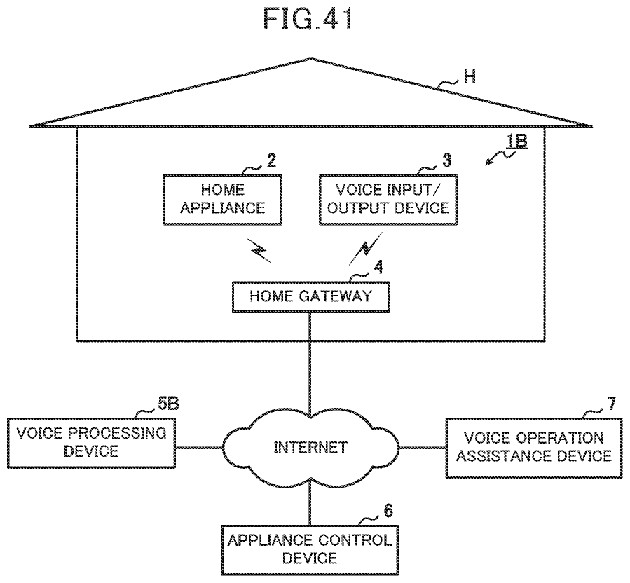

FIG. 41 is a diagram illustrating an overall configuration of a voice operation system 1B including a voice operation assistance system according to Embodiment 3 of the present disclosure. The voice operation system 1B includes one or more home appliances 2, a voice input/output device 3, a home gateway 4, a voice processing device 5B, an appliance control device 6, and a voice operation assistance device 7. The voice operation assistance system according to Embodiment 3 includes the voice input/output device 3, the home gateway 4, the voice processing device 5B, and the voice operation assistance device 7.

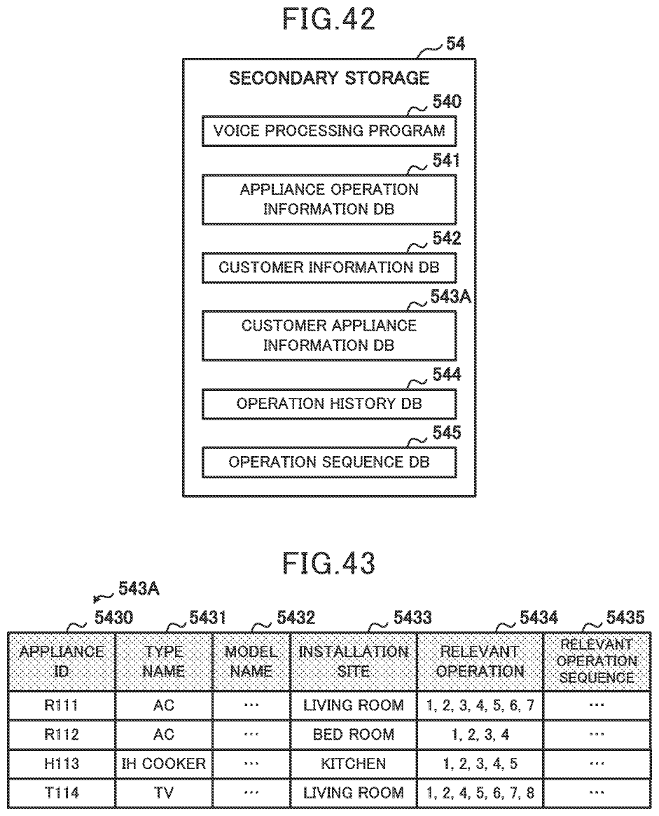

The hardware configuration of the voice processing device 5B is similar to that of the voice processing device 5 of Embodiment 1 (see FIG. 4). However, as illustrated in FIG. 42, a secondary storage 54 of the voice processing device 5B stores a customer appliance information DB 543A in place of the customer appliance information DB 543, and further stores an operation history DB 544 and an operation sequence DB 545.

Similarly to the customer appliance information DB 543, the customer appliance information DB 543A is a database where information relating to all the home appliances 2 installed at each customer's home is registered. In addition to the items similar to the customer appliance information DB 543, the record registered in the customer appliance information DB 543A includes a relevant operation sequence 5435, as illustrated in FIG. 43.

The relevant operation sequence 5435 stores information relating to the relevant operation sequence information. The operation sequence information is information for enabling a voice operation relative to a single home appliance 2 to achieve automatic sequential execution of operations relative to another one or more home appliances 2, and is registered in the operation sequence DB 545 described later. The information stored in the relevant operation sequence 5435 stores a registration number, a sequence number, and the like of the relevant operation sequence information. The registration number and the sequence number are described later. For a case where there is no relevant operation sequence information, the relevant operation sequence 5435 stores information providing indication to such effect.

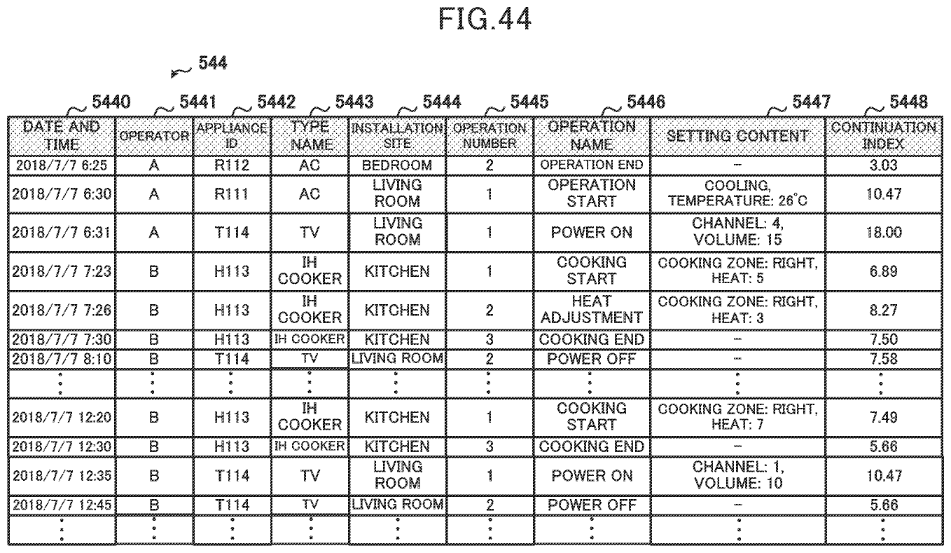

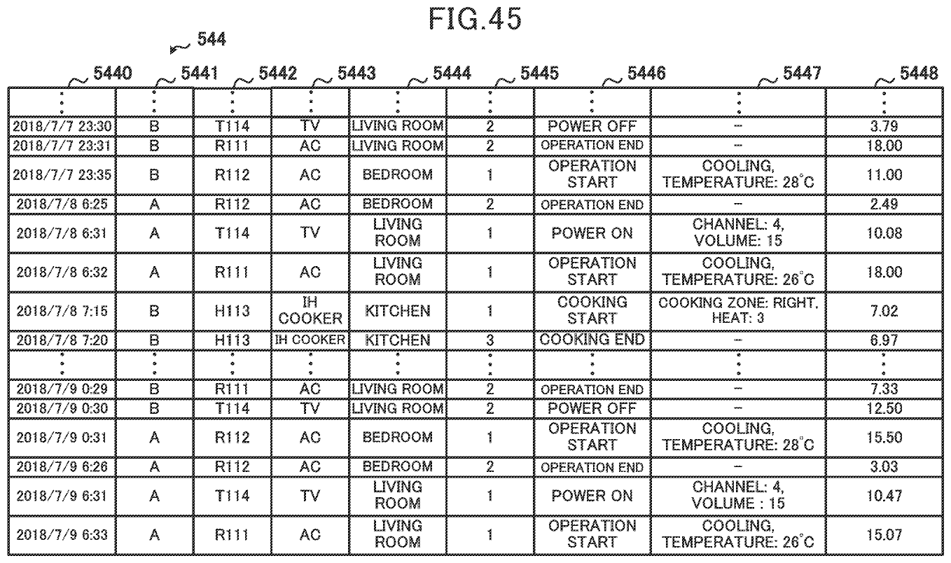

With reference again to FIG. 42, the operation history DB 544 is a database where a history of the voice operations in each customer's home is registered. Specifically, as illustrated in FIGS. 44 and 45, the operation history DB 544 has, for each customer, a record, over a predetermined period, including items of a date and time 5440, an operator 5441, an appliance ID 5442, a type name 5443, an installation site 5444, an operation number 5445, an operation name 5446, setting content 5447, a continuation index 5448, and the like.

The date and time 5440 stores information indicating a date and time (year/month/date/time) at which the operation is performed. The operator 5441 stores a name of the operator having performed the operation. The appliance ID 5442 stores an appliance ID of the operated home appliance 2. The type name 5443 stores a name of the type to which the home appliance 2 belongs. The installation site 5444 stores a name indicating the installation site of the home appliance 2. The operation number 5445 stores an operation number of the operation. The operation name 5446 stores the operation name of the operation. The setting content 5447 stores setting content set in the operation.

The continuation index 5448 stores a continuation index. The continuation index is an index indicating continuity with the last operation. The continuation index is described later in detail.

With reference again to FIG. 42, the operation sequence DB 545 is a database in which the aforementioned operation sequence information is registered. The operation sequence information is registered, by a user of the voice operation service, in the operation sequence DB 545 by operation via a smartphone, a tablet terminal, or the like on which the aforementioned voice operation app runs. Alternatively, the operation sequence information may be generated based on the operation history DB 544 of each customer and registered in the operation sequence DB 545 by the voice processing device 5B. Alternatively, the operation sequence information may be generated by a provider of the voice operation service, and previously registered in the operation sequence DB 545.

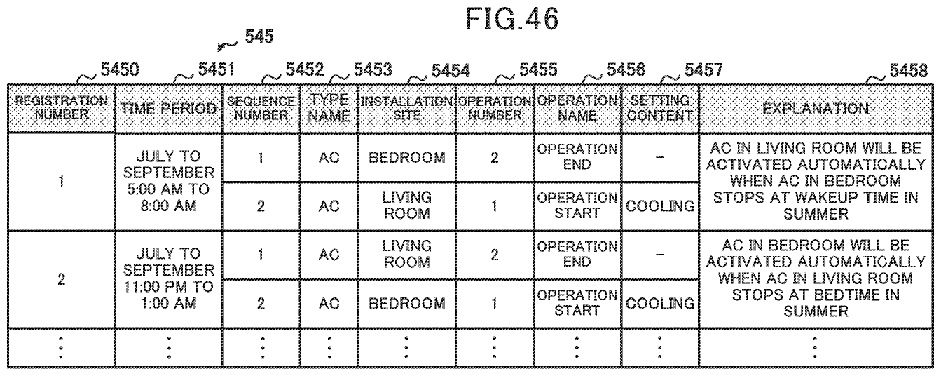

As illustrated in FIG. 46, the operation sequence information DB 545 has registered records of items including a registration number 5450, a time slot 5451, a sequence number 5452, a type name 5453, an installation site 5454, an operation number 5455, an operation name 5456, setting content 5457, an explanation 5458, and the like. A single operation sequence information entry includes a plurality of records. The registration number 5450 stores a registration number. The registration number indicates an order of registration in the operation sequence information DB 545 of the operation sequence information. The records associated with the same operation sequence information are assigned the same registration number.

The time slot 5451 stores information indicating a time slot (hereinafter referred to as time slot information) for which the operation based on the operation sequence information is effective. The time slot information includes information indicating each of a target month and a target time. The time slot 5451 of each record associated with the same sequence information stores the same time slot information.

The sequence number 5452 stores a sequence number. The sequence number indicates an order of executing operations in the operation sequence information. The type name 5453 stores a name of a type of the home appliance 2 that is a target of the operation.

The installation site 5454 stores a name indicating the installation site of the home appliance 2. The operation number 5455 stores an operation number of the operation. The operation name 5456 stores an operation name of the operation. The setting content 5457 stores setting content set in the operation. The description 5458 stores information indicating an explanation about the operation sequence information, which information is hereinafter referred to as explanation information. The same explanation information is stored for the explanation 5458 of each record associated with the same operation sequence information.

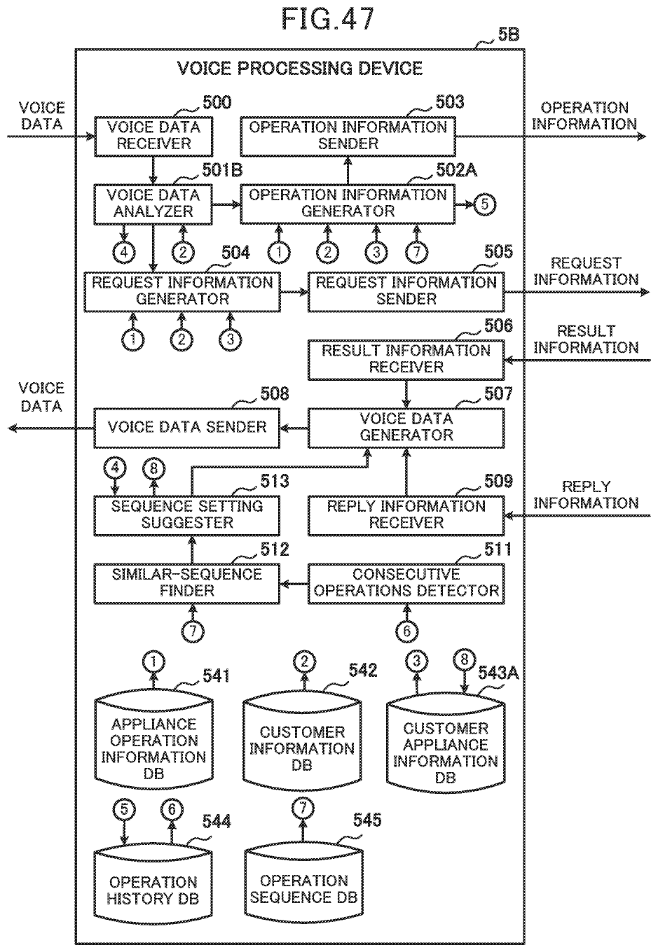

As illustrated in FIG. 47, the voice processing device 5B functionally includes a voice data receiver 500, a voice data analyzer 501B, an operation information generator 502A, an operation information sender 503, a request information generator 504, a request information sender 505, a result information receiver 506, a voice data generator 507, a voice data sender 508, a reply information receiver 509, a consecutive operations detector 511, a similar-sequence finder 512, and a sequence setting suggester 513.

The voice data analyzer 501B executes processing similar to the voice data analyzer 501 of the voice processing device 5 of Embodiment 1. That is, the voice data analyzer 501B analyzes the voice data received by the voice data receiver 500, and generates voice content data indicating utterance content of the user. When the generated voice content data indicates an operation relative to the home appliance 2, the voice data analyzer 501B supplies the voice content data to the operation information generator 502A. In addition, the voice data analyzer 501B identifies, with reference to the customer information DB 542, the user (that is, an operator) who uttered, and supplies a name of the identified operator to the operation information generator 502A. Data relating to the voice of each user in each of the customer's homes is assumed to be registered in the customer information DB 542.

When the generated voice content data indicates a reply to a suggestion of the operation sequence setting, the voice data analyzer 501B supplies the voice content data to the sequence setting suggester 513.

The operation information generator 502A generates operation information based on the voice content data supplied from the voice data analyzer 501B, the appliance operation information DB 541, the customer information DB 542, the customer appliance information DB 543A, and the operation sequence DB 545,

The operation information generator 502A generates the record indicating a history of the operation and registers the record in the operation history DB 544. At that time, the operation information generator 502A calculates the continuation index of the operation for storage in the continuation index 5448. The continuation index is calculated by the following equation 2.

continuation index=\sqrt{1/[interval]}×10+[operator]×0.5+(1−[appliance])×5+(1−[type])×0.5+[installation site]×2 (equation 2)

In each parameter of the above equation 2, the parameter [interval] is time (min) elapsed from the last operation. The parameter [operator] is “1” when the current operator and the last operator are the same, and “0” when they are different. The parameter [appliance] is “1” when the currently operated home appliance 2 and the last operated home appliance 2 are the same, and “0” when they are different. The parameter [type] is “1” when the type of the currently operated home appliance 2 and the type of the last operated home appliance 2 are the same, and “0” when they are different. The parameter [installation site] is “1” when the installation site of the currently operated home appliance 2 and the installation of the last operated home appliance 2 are the same, and “0” when they are different.

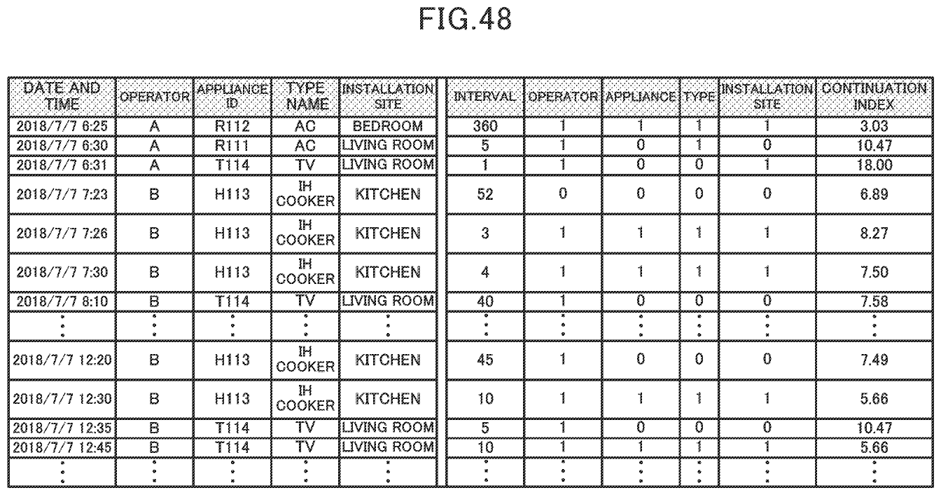

For example, in each operation illustrated in FIG. 44, the value of each parameter above is as in FIG. 48.

In the equation 2 above, a weight by which each parameter is multiplied is set in consideration of the effect of the parameter on continuity of the operation. In this example, the weight corresponding to the parameter [interval] is the greatest and set to “10”, and the weights corresponding to the parameters [operator] and [type] are the smallest and each set to “0.5”.

The continuation index can be derived in various ways, for example, by a recurrent neural network (RNN) of deep learning and the like.

With reference again to FIG. 47, the consecutive operations detector 511 checks the operation history DB 544 at a predetermined timing (for example, every certain period of time), and detects operations for which continuity can be observed, which operations are hereinafter referred to as consecutive operations. Specifically, when there is an operation whose continuation index is a predetermined reference value (for example, 10.00) or more, the consecutive operations detector 511 detects, as the consecutive operations, such operation and an operation immediately beforehand. When operations continue whose continuation index is the reference value or more, three or more operations are included in the consecutive operations.

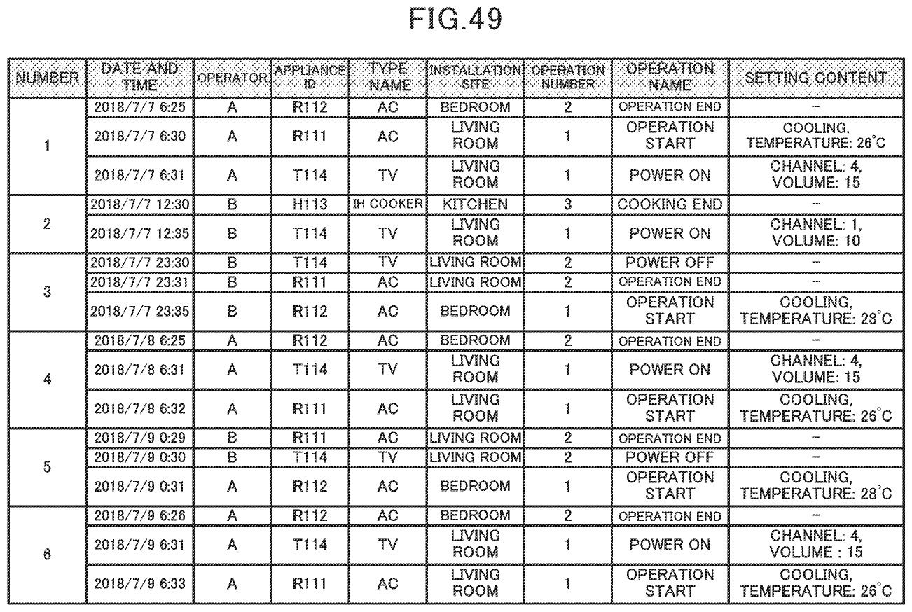

The consecutive operations detector 511 stores the information relating to the detected consecutive operations in a non-illustrated consecutive operations table. The consecutive operations table is developed using the RAM 53 or the secondary storage 54. FIG. 49 illustrates an example of the consecutive operations table.

With reference again to FIG. 47, the similar-sequence finder 512 finds the operation sequence information included in the consecutive operations detected by the consecutive operations detector 511. Specifically, the similar-sequence finder 512 sequentially picks up consecutive operations from the consecutive operations table, and finds from the operation sequence DB 545 the operation sequence information included in the picked-up consecutive operations.

For example, in the consecutive operations table illustrated in FIG. 49, each of the consecutive operations whose numbers are “1”. “4”, and “6” includes the operation sequence information whose registration number is “1” in the operation sequence DB 545 (see FIG. 46).

When the same operation sequence information appears a defined number of times (for example, three times) or more as a result of the above finding about each of the consecutive operations in the consecutive operations table, the similar-sequence finder 512 notifies the sequence setting suggester 513 of the registration number of the operation sequence information.

The sequence setting suggester 513 is an example of sequence setting suggesting means according to the present disclosure. The sequence setting suggester 513 generates suggestion information for suggesting settings (hereinafter referred to as sequence settings) of a series of operations indicated by the operation sequence information having the registration number given in the notification. The suggestion information includes explanation information retrieved from the explanation 5458 in the record corresponding to the registration number of the operation sequence DB 545. The sequence setting suggester 513 supplies the generated suggestion information to the voice data generator 507.

The voice data generator 507 generates, based on the suggestion information supplied from the sequence setting suggester 513, voice data by known voice synthesis processing, and supplies the generated voice data to the voice data sender 508. The voice data sender 508 sends to the voice input/output device 3 the voice data supplied from the voice data generator 507.

Upon getting from a user an affirmative reply to the above suggestion, such as, “Yes”, “OK”, “please”, “try”, and so on, the sequence setting suggester 513 performs sequence setting with respect to the home appliances 2 at the customer's home. Specifically, the sequence setting suggester 513 stores information (registration number, sequence number, etc.) relating to the operation sequence information in the relevant operation sequence 5435 of the record corresponding to the home appliance 2 that is a target of the sequence settings in the customer appliance information DB 543A.

Upon generating operation information from the voice content data based on the voice operation of a user and supplying the generated operation information to the operation information sender 503, the operation information generator 502A determines, based on the current date and time, the customer appliance information DB 543A, and the operation sequence DB 545, whether or not the home appliance 2 to be operated is the first home appliance 2 in the sequence operation to be executed. For example, when the current date and time is at 6 am on August 1 and the registration number “1” and the sequence number “1” are stored in the relevant operation sequence 5435 of the record corresponding to the home appliance 2 in the customer appliance information DB 543A, the operation information generator 502A determines that the home appliance 2 corresponds to the first home appliance 2 in the sequence operation to be executed.

Upon determination that the home appliance 2 corresponds to the first home appliance in the sequence operation to be executed, the operation information generator 502A generates, in an ascending order of the sequence number, the operation information relative to the home appliance 2, having the same registration number, to which the sequence number of “2” or higher is set, and sequentially supplies the generated operation information to the operation information sender 503. For example, when running of the AC in the bedroom at the user's home is stopped by the voice operation at 5 to 8 am in July to September, running of the AC in the living room automatically starts.

As described above, according to the voice operation assistance system according to Embodiment 3, the voice processing device 5B suggests to the user settings of the consecutive operations relative to the home appliances 2, that is, the sequence settings from a user's daily tendency of operations with respect to the home appliances 2. Then upon consent by the user, the voice processing device 5B performs the sequence settings for achieving the consecutive operations. This enables the user to execute each of the desired operations sequentially using the home appliances 2 with a single voice operation. Thus, user convenience is enhanced.

The voice processing device 5B may suggest to the user without reference to the operation sequence DB 545 the sequence settings about the home appliances that are consecutively operated frequently.

The suggestions and setting functions of the sequence settings by the voice processing device 5B may be included in the appliance control device 6 or the voice operation assistance device 7.

Instead of the voice operation assistance device 7, the voice processing device 5B may have capabilities equivalent to the voice operation assistance device 7, or the appliance control device 6 may have capabilities equivalent to the voice operation assistance device 7.

The voice processing device 5B, the appliance control device 6, and the voice operation assistance device 7 may be implemented as a single device.

The suggestions and setting functions of the sequence settings by the voice processing device 5B may be included in voice processing device 5A of Embodiment 2.

The present disclosure is not limited to each of the above embodiments, and various modifications can be of course made within a scope that does not depart from the gist of the present invention.

In each embodiment above, the functional components (see FIGS. 17, 31, and 47) of the voice processing device 5, 5A, 5B are achieved by execution by the CPU 51 of the voice processing program 540 stored in the secondary storage 54. However, all or a part of the functional components of the voice processing device 5, 5A, 5B may be achieved by use of dedicated hardware. Similarly, all or a part of the functional components (see FIG. 26) of the appliance control device 6 may be achieved by the use of dedicated hardware, or all or a part of the functional components (FIGS. 27 and 37) of the voice operation assistance device 7, 7A may be achieved by the use of dedicated hardware. The dedicated hardware is, for example, a single circuit, a composite circuit, a programmed processor, an application specific integrated circuit (ASIC), a field-programmable gate array (FPGA), or a combination thereof.

The voice processing program 540, the appliance control program 640, and the voice operation assistance program 740 can be stored for distribution in a computer-readable recording medium such as compact disc read only memory (CD-ROM), a digital versatile disc (DVD), a magneto-optical disc, a universal serial bus (USB) memory, a memory card, an HDD, or the like. Then installing the voice processing program 540, the appliance control program 640, and the voice operation assistance program 740 distributed as such into a dedicated or general-purpose computer also enables the computer to function as the voice processing device 5, 5A, 5B, the appliance control device 6, and the voice operation assistance device 7, 7A.

The voice processing program 540, the appliance control program 640, and the voice operation assistance program 740 may be stored in a storage included in non-illustrated server on the Internet, and the voice processing program 540, the appliance control program 640, and the voice operation assistance program 740 may be downloaded from the server to the voice processing device 5, 5A, 5B, the appliance control device 6, and the voice operation assistance device 7, 7A.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure can be used with advantage in a system for controlling a home appliance by voice of a user.

### REFERENCE SIGNS LIST

1, 1A, 1B Voice operation system
2 Home appliance
3 Voice input/output device
4 Home gateway
5, 5A, 5B Voice processing device
6 Appliance control device
7, 7A Voice operation assistance device
30 Microphone
31 A/D converter
32 Loudspeaker
33, 50, 60, 70 Communication interface
34, 51, 61, 71 CPU
35, 52, 62, 72 ROM
36, 53, 63, 73 RAM
37, 54, 64, 74 Secondary storage
38, 55, 65, 75 Bus
300 Voice inputter
301 Sender
302 Receiver
303 Voice outputter
500 Voice data receiver
501, 501A, 501B Voice data analyzer
502, 502A Operation information generator
503 Operation information sender
504, 504A Request information generator
505 Request information sender
506 Result information sender
507 Voice data generator
508 Voice data sender
509 Reply information receiver
510 Advice information receiver
511 Consecutive operations detector
512 Similar-sequence finder
513 Sequence setting suggester
600 Operation information receiver
601 Control command generator
602 Control command sender
603 Response data receiver
604 Result information sender
700, 700A Request information receiver
701 Request information analyzer
702 Reply information generator
703 Reply information sender
704 Advice information generator
705 Advice information sender

1. A voice operation assistance system comprising:
a voice data receiver to receive, from a voice input/output device, first voice data based on voice of a user;
a reply information generator to, when the received first voice data indicates an inquiry about an operation for a home appliance that the user has, generate reply information in reply to the inquiry with reference to an operation explanation information database in which, for each home appliance type, one or more manufacturer-specific operations of each of a plurality of manufacturers relative to the home appliance type are each associated with information indicating an explanation; and
a voice data sender to send to the voice input/output device second voice data indicating voice based on the reply information.

2. The voice operation assistance system according to claim 1, further comprising:
an advice information generator to generate, based on a status of usage of each of the manufacturer-specific operations of the home appliance that the user has, advice information that prompts the user to perform the manufacturer-specific operation, wherein
the voice data sender further sends, to the voice input/output device, third voice data indicating voice based on the advice information.

3. The voice operation assistance system according to claim 1, further comprising a sequence setting suggester to suggest, based on an operation history of a plurality of home appliances that the user has, that the user set consecutive operations for different home appliances.

4. (canceled)

5. A voice processing device comprising:
a voice data receiver to receive, from a voice input/output device, first voice data based on voice of a user;
a reply requester to, when the received first voice data indicates an inquiry about an operation for a home appliance that the user has, request, from a voice operation assistance device, reply information indicating a reply to the inquiry; and
a voice data sender to send, to the voice input/output device, second voice data indicating voice based on the reply information obtained from the voice operation assistance device.

6. A voice operation assistance device comprising:
a storage to store an operation explanation information database in which, for each home appliance type, one or more manufacturer-specific operations of each of a plurality of manufacturers relative to the home appliance type are each associated with information indicating an explanation; and
a replyer to generate, with reference to the operation explanation information database, reply information in reply to an inquiry from a voice processing device about an operation for a home appliance that a user has, and send the reply information to the voice processing device.

7. The voice operation assistance device according to claim 6, further comprising an advice information generator to generate, based on a status of usage of each of the manufacturer-specific operations of the home appliance that the user has, advice information that prompts the user to perform the manufacturer-specific operation, and send the advice information to the voice processing device.

8-12. (canceled)
